(19) United States
(12) Patent Application Publication
(10) Pub. No.: US 2009/0203435 A1
(43) Pub. Date: Aug. 13, 2009

(54) Gaming machine sharing payout resources for special game with other gaming machines and playing method thereof

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/216,875

(22) Filed: Jul. 11, 2008

Related U.S. Application Data
(60) Provisional application No. 61/027,666, filed on Feb. 11, 2008.

(51) Int. Cl. A63F 9/24; G07F 17/32

(52) U.S. Cl. 463/27

(57) ABSTRACT

In a gaming machine, a unit game in which arranged symbols are rearranged is displayed on a first display, and a character corresponding to a probability by which a specific symbol is rearranged in the unit game is displayed on a second display. When a command from a payout controller is received, a special game for executing the unit game for a prescribed number of times is executed at the gaming machine. When a prescribed condition is realized in conjunction with a rearrangement of symbols including the specific symbol in the unit game during this special game, a payment of credit as a payout for the special game is executed in conjunction with an end of a period of the special game. A level of difficulty by which the prescribed condition is realized during the special game is different for the gaming machine using a symbol with a high rearrangement probability in the unit game as the specific symbol and the gaming machine using a symbol with a low rearrangement probability as the specific symbol. Consequently, the gaming machines with different rearrangement probabilities for the specific symbol in the unit game have different gambling thrills regarding the payout for the special game.

### CROSS REFERENCE TO RELATED APPLICATIONS

This application claims priority to co-pending U.S. provisional patent application Ser. No. 61/027,666 filed on Feb. 11, 2008, and which is incorporated by reference herein for all purposes.

### BACKGROUND OF THE INVENTION

1. Field of the Invention

The present invention relates to a gaming machine sharing payout resources for special game with other gaming machines and a playing method thereof.

2. Description of the Related Art

As described in U.S. Pat. No. 5,820,459 specification, U.S. Pat. No. 6,695,697 specification, U.S. Patent Application Publication No. 2003/0,069,073 specification, European Patent Application Publication No. 1,192,975 specification, U.S. Pat. No. 6,254,483 specification, U.S. Pat. No. 5,611,730 specification, U.S. Pat. No. 5,639,088 specification, U.S. Pat. No. 6,257,981 specification, U.S. Pat. No. 6,234,896 specification, U.S. Pat. No. 6,001,016 specification, U.S. Pat. No. 6,273,820 specification, U.S. Pat. No. 6,224,482 specification, U.S. Pat. No. 4,669,731 specification, U.S. Pat. No. 6,244,957 specification, U.S. Pat. No. 5,910,048 specification, U.S. Pat. No. 5,695,402 specification, U.S. Pat. No. 6,003,013 specification, U.S. Pat. No. 4,283,709 specification, European Patent Application Publication No. 0,631,798 specification, German Patent Application Publication No. 4,137,010 specification, British Patent Application Publication No. 2,326,830 specification, German Patent Application Publication No. 3,712,841 specification, U.S. Pat. No. 4,964,638 specification, U.S. Pat. No. 6,089,980 specification, U.S. Pat. No. 5,280,909 specification, U.S. Pat. No. 5,702,303 specification, U.S. Pat. No. 6,270,409 specification, U.S. Pat. No. 5,770,533 specification, U.S. Pat. No. 5,836,817 specification, U.S. Pat. No. 6,932,704 specification, U.S. Pat. No. 6,932,707 specification, U.S. Pat. No. 4,837,728 specification, European Patent Application Publication No. 1,302,914 specification, U.S. Pat. No. 4,624,459 specification, U.S. Pat. No. 5,564,700 specification, PCT Patent Application Publication No. 03/083,795 specification, German Patent Application Publication No. 3,242,890 specification, European Patent Application Publication No. 0,840,264 specification, German Patent Application Publication No. 10,049,444 specification, PCT Patent Application Publication No. 04/095,383 specification, European Patent Application Publication No. 1,544,811 specification, U.S. Pat. No. 5,890,963 specification, European Patent Application Publication No. 1,477,947 specification, and European Patent Application Publication No. 1,351,180 specification, in a facility in which gaming machines such as slot machines are provided, a player can play a game provided by a gaming machine by making bets such as coins, credits, etc., at that gaming machine.

For example, the slot machine executes a slot game in which a plurality of symbols arranged on a display are rearranged every time a player makes bets and presses a start switch at the slot machine. Then, I the case where the symbols rearranged on a display contain a prescribed number of scatter symbols or a prescribed winning combination is realized on a payline, the slot machine makes a payout according to that content.

In addition, the slot machine also makes a payout called jackpot in which the payout amount is increased accumulatively. In a certain type of slot machine, a part (some) of bets made at this slot machine is deposited for a payout of the jackpot. Such depositing of a part of bets can be an example of a method for accumulatively increasing the payout of the jackpot.

The slot machine determines whether or not to make the payout of the jackpot at a prescribed timing, and in the case where it is determine to make the payout of the jackpot, a part or a whole of bets deposited for the payout of the jackpot will be paid to the player.

In the case of a gaming machine that is representatively exemplified by the slot machine described above, there are cases where the jackpot is shared by connecting a plurality of gaming machines through a network, in order to make the deposited amount for the jackpot larger. Whether or not to make the payout of such a shared jackpot, and to which gaming machine the payout is to be made, will be determined by an outcome of a special game executed at each gaming machine on the network when a prescribed condition is realized. In many cases, the special game is a slot game that can be executed without making any bet, that is, a free game, which is also referred to as a feature game. The rule of the free game is common to all gaming machines, so that a probability by which the payout from the jackpot can be obtained is the same for all gaming machines.

Consequently, the player can only enjoy the same gambling thrill regarding the payout from the jackpot, no mater which gaming machine is used for playing the game. Also, because the rule of the free game is common to all gaming machines, even when the player tries to select a gaming machine with a tendency regarding the payout of the jackpot that suits his own preference, there is no criterion to make that selection.

### SUMMARY OF THE INVENTION

The present invention has an object to provide a gaming machine and a playing method thereof with superior entertainment quality, in which payout resources for a free game that is representatively exemplified by the jackpot are shared with other gaming machines.

The first aspect of the present invention is a gaming machine comprising: a first display configured to display a unit game in which a plurality of arranged symbols are rearranged; a second display configured to display a character corresponding to a probability by which a specific symbol is rearranged in the unit game; and a machine controller configured to (a) execute a special game including the unit game for a prescribed number of times, according to a command from a payout controller, the gaming machine being connected to the payout controller along with other gaming machines, the gaming machine and each of the other gaming machines having different rearrangement probabilities for the specific symbol, and (b) provide an award for the special game after a period of the special game, when a prescribed condition associated with a rearrangement of symbols including the specific symbol during the special game is fulfilled.

The second aspect of the present invention is a gaming machine comprising: a first display configured to display a unit game in which a plurality of arranged symbols are rearranged; a second display configured to display a character corresponding to a probability by which a specific symbol is rearranged in the unit game; and a machine controller configured to (a) execute a special game including the unit game for a prescribed number of times, according to a command from a payout controller, the gaming machine being connected to the payout controller along with other gaming machines, the gaming machine and each of the other gaming machines having different rearrangement probabilities for the specific symbol, and (b) provide an award for the special game in an amount based on a game number of unit games in which a predetermined number of special symbols are rearranged during the special game, the predetermined number corresponding to the rearrangement probability for the special symbol.

The third aspect of the present invention is a gaming machine comprising: a first display configured to display a unit game in which a plurality of arranged symbols are rearranged; a second display configured to display a character corresponding to a probability by which a specific symbol is rearranged in the unit game; and a machine controller configured to (a) execute a special game including the unit game for a prescribed number of times, according to a command from a payout controller, the gaming machine being connected to the payout controller along with other gaming machines, the gaming machine and each of the other gaming machines having different rearrangement probabilities for the specific symbol, and (b) provide an award for the special game in an amount based on a total value of points during the special game, the points being given each time symbols are rearranged in a specific pattern with a level of difficulty of occurrence corresponding to a rearrangement probability of the specific symbol during the special game in an amount corresponding to the rearrangement probability of the specific symbol in the unit game.

The fourth aspect of the present invention is a method of playing a gaming machine, comprising the steps of: displaying a unit game in which a plurality of arranged symbols are rearranged, on a first display; displaying a character corresponding to a probability by which a specific symbol is rearranged in the unit game, on a second display; executing a special game including the unit game for a prescribed number of times, according to a command from a payout controller, the gaming machine being connected to the payout controller along with other gaming machines, the gaming machine and each of the other gaming machines having different rearrangement probabilities for the specific symbol, and providing an award as a payout for the special game after a period of the special game, when a prescribed condition associated with a rearrangement of symbols including the specific symbol during the special game is fulfilled.

### BRIEF DESCRIPTION OF THE DRAWINGS

FIG. 1 is a flow chart showing an operation of a slot machine which is one example of a gaming machine according to the present invention and an outline of its playing method.

FIG. 2 is an explanatory diagram showing an exemplary display to be displayed on a liquid crystal display of a slot machine according to the first embodiment of the present invention.

FIG. 3 is an explanatory diagram showing partitioned regions in a matrix shape that are provided on a display of a slot machine according to the first embodiment of the present invention.

FIG. 4 is a perspective view of a slot machine according to the first embodiment of the present invention.

FIG. 5 is a block diagram showing a control circuit of a slot machine according to the first embodiment of the present invention.

FIG. 6A is a perspective view showing a rotation reel device of a slot machine according to the first embodiment of the present invention.

FIG. 6B is a side view showing a rotation reel device of a slot machine according to the first embodiment of the present invention.

FIG. 7 is an explanatory diagram showing a schematic configuration of symbols arranged on circumferential faces of rotation reels of a slot machine according to the first embodiment of the present invention.

FIG. 8 is an explanatory diagram showing a schematic configuration of a slot machine system according to the first embodiment of the present invention.

FIG. 9 is an explanatory diagram showing a schematic configuration of symbols arranged on circumferential faces of rotation reels of another slot machine according to the first embodiment of the present invention.

FIG. 10 is an explanatory diagram showing a schematic configuration of symbols arranged on circumferential faces of rotation reels of still another slot machine according to the first embodiment of the present invention.

FIG. 11 is a flow chart showing a processing procedure of a slot machine according to the first embodiment of the present invention.

FIG. 12 is a flow chart showing a processing procedure of a slot machine according to the first embodiment of the present invention.

FIG. 13 is a flow chart showing a processing procedure of a slot machine according to the first embodiment of the present invention.

FIG. 14 is a flow chart showing a processing procedure of a payout controller of a slot machine system according to the first embodiment of the present invention.

FIG. 15 is a flow chart showing a processing procedure of a payout controller of a slot machine system according to the first embodiment of the present invention.

FIG. 16 is a flow chart showing a processing procedure of a payout controller of a slot machine system according to the first embodiment of the present invention.

FIG. 17 is an explanatory diagram showing an exemplary display of a slot game to be executed on a display of a slot machine according to the first embodiment of the present invention.

FIG. 18 is an explanatory diagram showing an exemplary display of a slot game to be executed on a display of a slot machine according to the first embodiment of the present invention.

FIG. 19 is a flow chart showing a processing procedure of a slot machine according to the second embodiment of the present invention.

FIG. 20 is a flow chart showing a processing procedure of a slot machine according to the second embodiment of the present invention.

FIG. 21 is a flow chart showing a processing procedure of a payout controller of a slot machine system according to the second embodiment of the present invention.

FIG. 22 is a flow chart showing a processing procedure of a payout controller of a slot machine system according to the second embodiment of the present invention.

FIG. 23 is a perspective view of a slot machine according to the third embodiment of the present invention.

FIG. 24 is a block diagram showing a control circuit of a slot machine according to the third embodiment of the present invention.

### DETAILED DESCRIPTION OF THE EMBODIMENTS

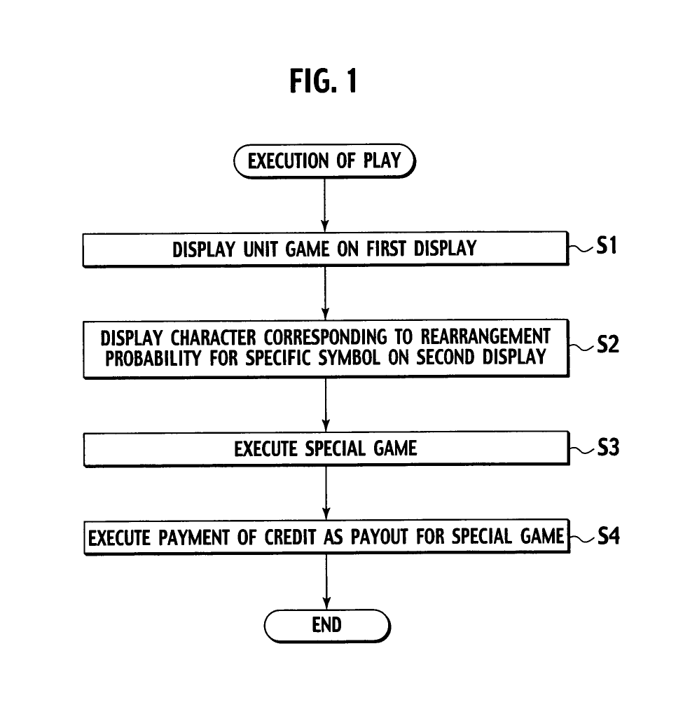

In the following, an operation of a slot machine which is one example of a gaming machine according to the present invention and an outline of its playing method will be described with references to FIG. 1 to FIG. 8.

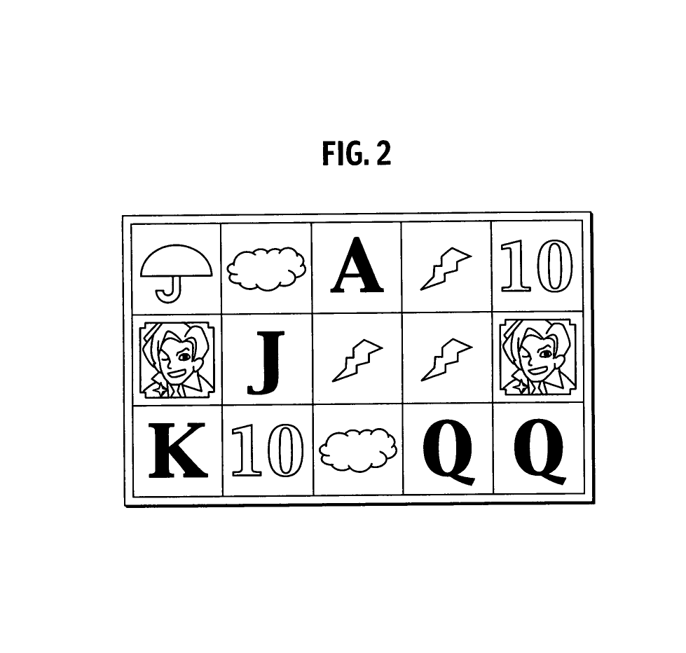

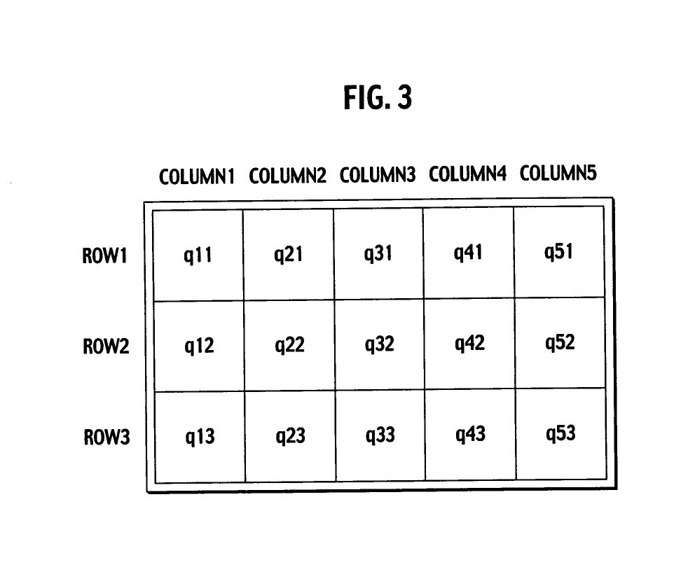

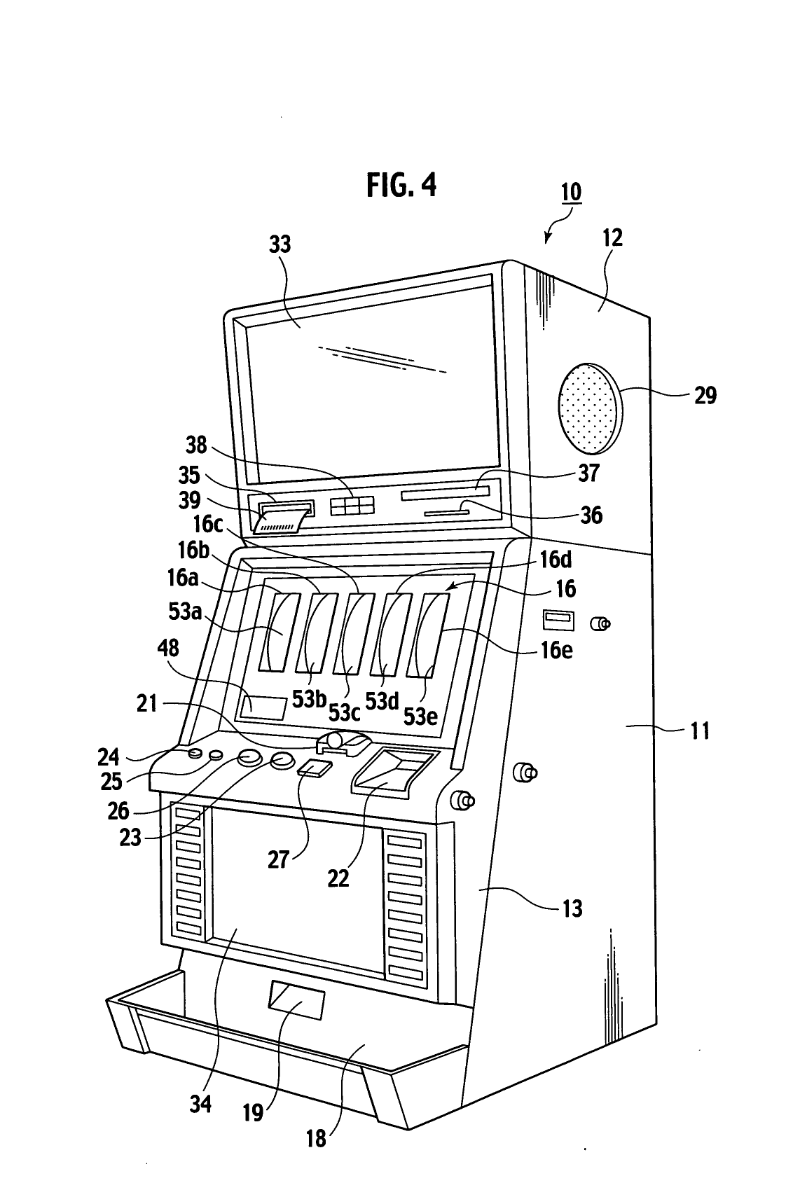

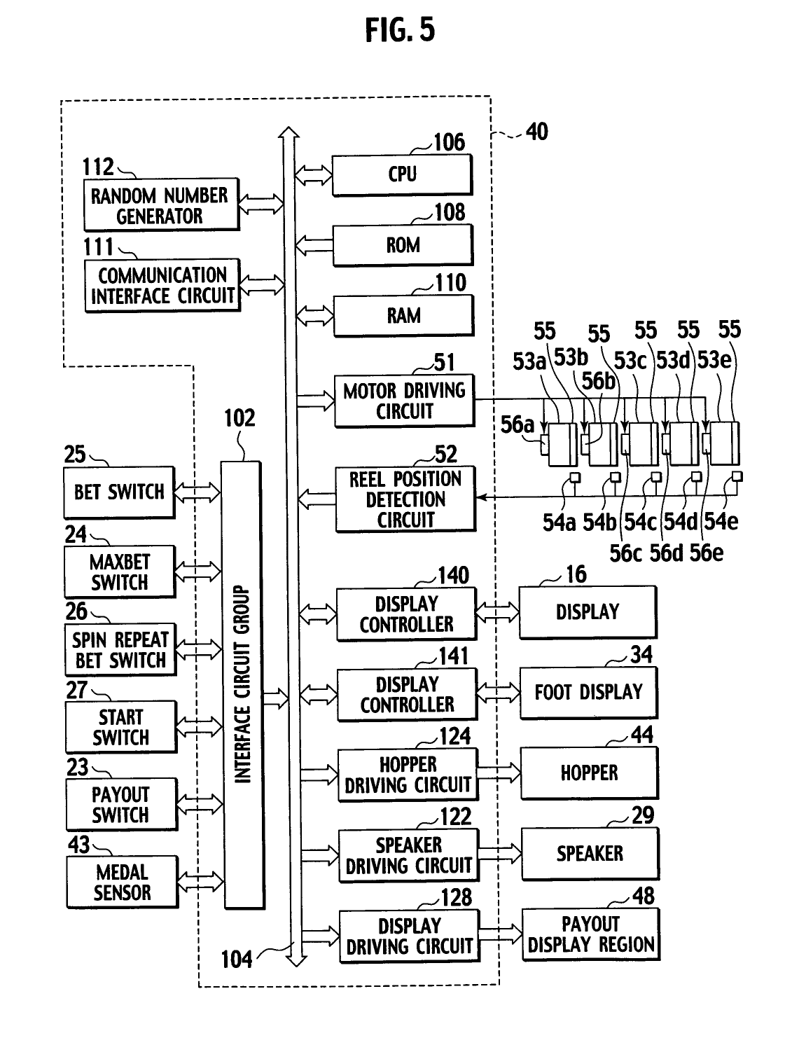

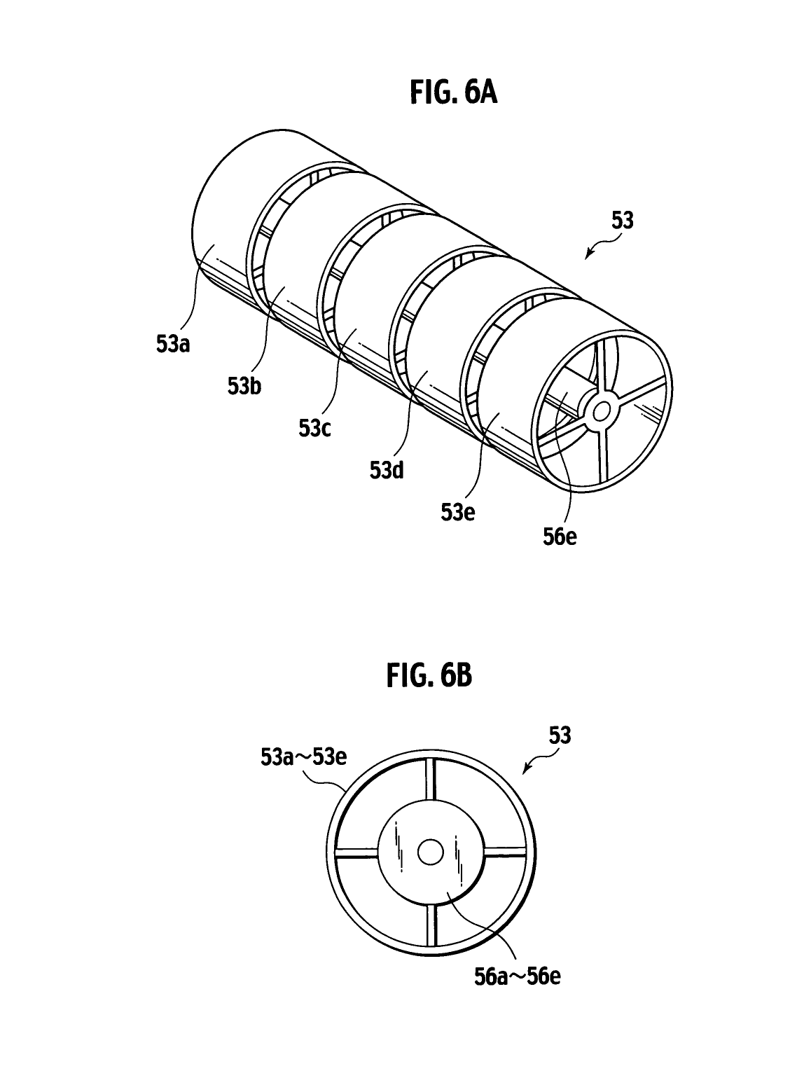

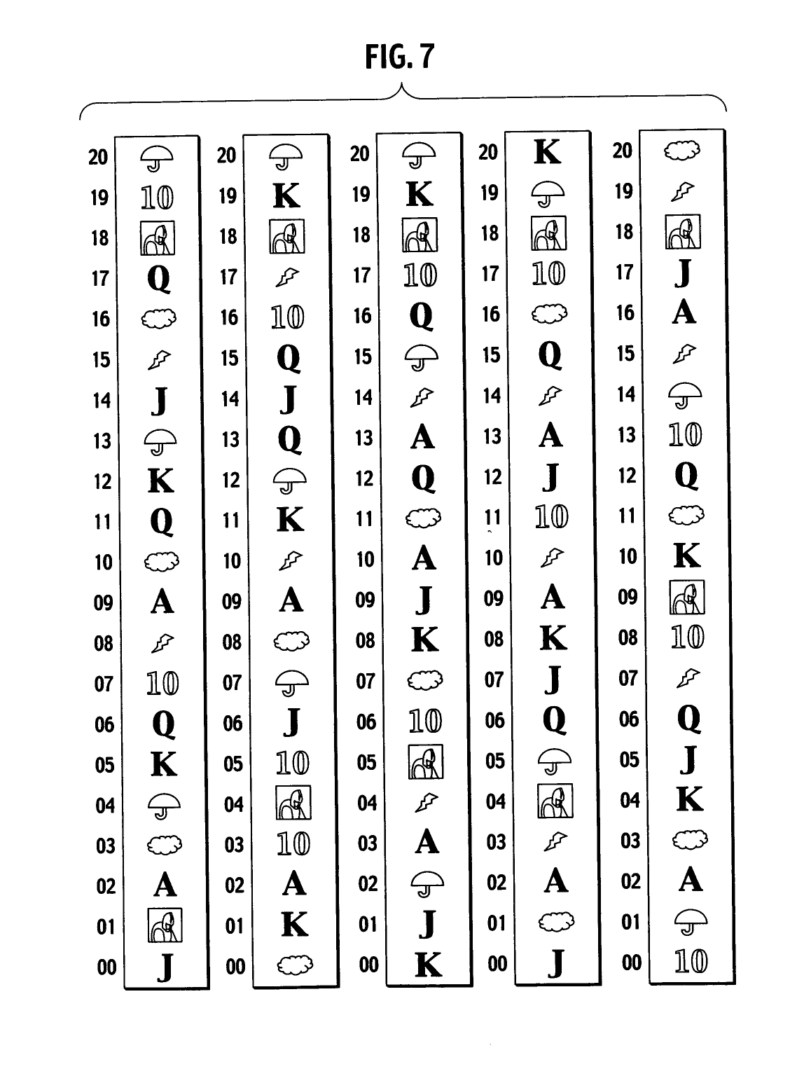

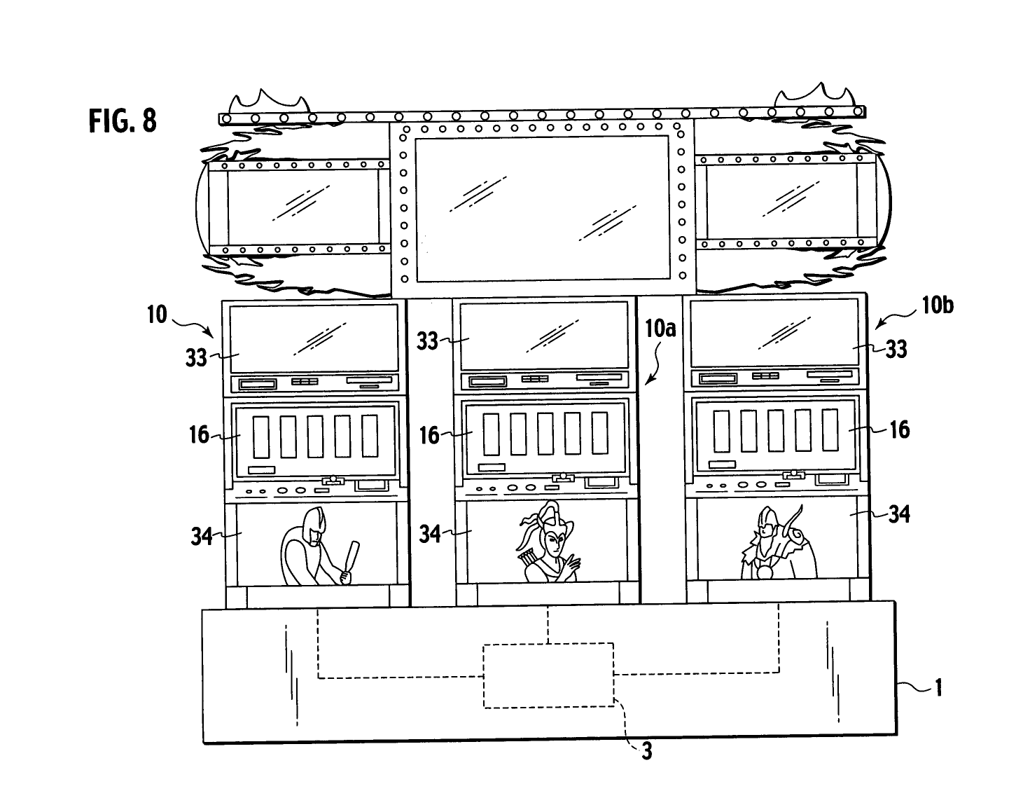

FIG. 1 is a flow chart showing an operation of a slot machine which is one example of a gaming machine according to the present invention and an outline of its playing method. FIG. 2 is an explanatory diagram showing an exemplary display to be displayed on a display of a slot machine according to one example of the present invention. FIG. 3 is an explanatory diagram showing partitioned regions in a matrix shape that are provided on a display of a slot machine according to one example of the present invention. FIG. 4 is a perspective view of a slot machine according to one example of the present invention. FIG. 5 is a block diagram showing a control circuit of a slot machine according to one example of the present invention. FIG. 6A is a perspective view showing a rotation reel device of a slot machine according to one example of the present invention. FIG. 6B is a side view showing a rotation reel device of a slot machine according to one example of the present invention. FIG. 7 is an explanatory diagram showing a schematic configuration of symbols arranged on circumferential faces of rotation reels of a slot machine according to one example of the present invention. FIG. 8 is an explanatory diagram showing a schematic configuration of a slot machine system containing a slot machine according to one example of the present invention.

On a front face of a cabinet 11 of a slot machine 10 shown in FIG. 4, a display 16 (corresponding to a first display in claims) is provided. This display 16 has 15 partitioned regions q11 to q53 as shown in FIG. 3. These partitioned regions q11 to q53 are arranged in a matrix shape formed by first to fifth columns and first to third rows.

In the slot machine 10 of FIG. 4 according to one example of the present invention, symbols arranged in the partitioned regions q11 to q53 of FIG. 3 described above are rearranged each time a unit game is executed. This unit game can be executed by rotating and then stopping rotation reels 53a to 53e behind the partitioned regions q11 to q53 of the display 16, for example.

The rotation reel device 53 has five rotation reels 53a to 53e corresponding to the windows 16a to 16e of the display 16, as shown in FIG. 6A. On a circumferential face of each of the rotation reels 53a to 53e, 21 symbols are laid out at equal intervals, as shown in FIG. 7. These symbols include nine types of symbols including “A (Ace card)”, “K (King card)”, “Q (Queen card)”, “J (Jack card)”, “10 (10 card)”, “Umbrella”, “Lightning”, “Cloud”, and “Character #1 (a face of a young male fighter)”.

Three symbols on each of the rotation reels 53a to 53e will be visible to a player through the corresponding partitioned regions q11 to q53. Consequently, the arrangement and the rearrangement of the symbols are carried out by rotation and stopping of the rotation reels 53a to 53e.

Then, when the symbols are rearranged in the partitioned regions q11 to q53 in a unit game, a payout credit (award) amount is determined according to predetermined rules of a payout table, and a payout of credit (award) in the determined payout amount is made. After that, as a next unit game is started, the symbols of the partitioned regions q11 to q53 will be rearranged.

As shown in FIG. 1, the slot machine 10 of FIG. 4 according to one example of the present invention displays the unit game for rearranging a plurality of arranged symbols as described above on the first display that can be formed by the display 16 of FIG. 3 (step S1).

This unit game can be made such that it becomes possible to execute it when a player makes bets. More specifically, this betting can be made in such a way that a player inserts medals or coins that are cashable credits that can be cashed, into the slot machine 10. The betting can also be made by allotting restricted credits that are stored in the slot machine 10 in an electronic form and that can be continually used as bets until they are cashed, to bets as much as specified by a player, by an operation of the slot machine 10 by a player.

Note that, in the following description, a unit of bets that can be bet by using the cashable credits or the restricted credits described above will be referred to as “credit”. For example, when one medal or coin is inserted into the slot machine 10 by a player as a bet, a betting of “1 credit” is made. Also, for example, when 2 restricted credits are allotted to bets by an operation of the slot machine 10 by a player, a betting of “2 credits” is made.

Before or after the display of the unit game described above, the slot machine 10 displays a character corresponding to a probability by which a specific symbol (a symbol “character #1” of FIG. 7, for example) is rearranged in the partitioned regions q11 to q53 in the unit game, on the second display that can be formed by the foot display 34 of FIG. 4 (step S2). The character displayed on the second display can be either a still image or a dynamic image.

The probability by which the specific symbol is rearranged in the partitioned regions q11 to q53 of the display 16 in the unit game can be expressed by a ratio, with respect to the number of all symbols including 21 symbols laid out on the circumferential face of each of the rotation reels 53a to 53e of FIG. 7, of the number of the specific symbols (symbols “character #1 (a face of a young male fighter)” contained among these symbols. In this example, the symbol “character #1 (a face of a young male fighter)” that is the specific symbol is displayed on the foot display 34, as the character corresponding to the rearrangement probability of the specific symbol.

Next, the slot machine 10 of FIG. 4 according to one example of the present invention executes a special game consisting of a prescribed number of times (20 times, for example) of the unit games (step S3), as shown in FIG. 1, according to a command from the payout controller 3 provided on a stage 1 on which the slot machine 10 is arranged as shown in FIG. 8. This special game is also referred to as a free game (feature game), for example.

Here, the special game to be executed by the slot machine 10 is for determining the credit amount to be paid as a payout according to its outcome. The payout for the special game can be set as that of the jackpot, for example. This jackpot can be formed by accumulating a part (some) of the bets made by a player each time the unit game is executed at the slot machine 10, for example. Consequently, the credit for the jackpot is accumulated progressively each time the unit game is executed at the slot machine 10. The accumulated credit for the jackpot can be managed at the payout controller 3.

Also, the command from the payout controller 3 which triggers the execution of the special game by the slot machine 10 can be a notification of a fact outputted to the slot machine 10 by the payout controller 3 when it is determined that the payout from the jackpot is to be generated, for example.

In addition, the jackpot described above can be shared with two other slot machines 10A and 10B whose operations are managed by the payout controller 3 along with the slot machine 10 as shown in FIG. 8. In this case, a part of the credit bet by a respective player as bets for the unit game at each of the slot machines 10, 10A and 10B will be deposited into the common jackpot. Consequently, the credit for the jackpot is progressively accumulated each time the unit game is executed at each of the slot machines 10, 10A and 10B.

Then, the slot machine 10 makes the payment of the credit as the payout for the special game, when a prescribed condition is realized (fulfilled) in the unit games that are to be executed for the prescribed number of times during a period of the special game (step S4). The prescribed condition here is one that is realized in conjunction with having symbols including the specific symbols rearranged in the partitioned regions q11 to q53 of the display 16 of FIG. 3.

More specifically, the prescribed condition can be regarded as realized when the number of unit games in which the a predetermined number or more (three or more, for example) of scatter symbols are rearranged in the partitioned regions q11 to q53 of the display 16 of FIG. 3 reaches a predetermined number of games (three games, for example).

Here, the scatter symbol can be the specific symbol (“character #1 (a face of a young male fighter)” of FIG. 7, for example). In that case, the slot machine 10 in which the number of the specific symbols (the symbol “character #1 (a face of a young male fighter)”) laid out on the circumferential face of each of the rotation reels 53a to 53e of FIG. 7 is greater will have a higher rearrangement probability for the scatter symbols. On the other hand, the slot machine 10 in which the number of the specific symbols laid out on the circumferential face of each of the rotation reels 53a to 53e is less will have a lower rearrangement probability for the scatter symbols.

At the slot machine 10 for which the rearrangement probability for the scatter symbols is high, the number of scatter symbols that are rearranged in the unit game becomes relatively greater. In contrast, at the slot machine 10 for which the rearrangement probability for the scatter symbols is low, the number of scatter symbols that are rearranged in the unit game becomes relatively less. For this reason, it is possible to set the predetermined number to be a relatively higher value at the slot machine 10 for which the rearrangement probability for the scatter symbols is high, than at the slot machine 10 for which the rearrangement probability for the scatter symbols is low, for example.

When the predetermined number is set in this manner, at the slot machine 10 for which the rearrangement probability for the scatter symbols is high, the prescribed condition for obtaining the payout for the special game will be realized by having the scatter symbols, that are rather easy to rearrange, rearranged in a large number in the unit game. On the other hand, at the slot machine 10 for which the rearrangement probability for the scatter symbols is low, the prescribed condition will be realized by having the scatter symbols, that are rather hard to rearrange, rearranged even in a small number in the unit game.

For this reason, the slot machine 10 for which the rearrangement probability for the scatter symbols is low can obtain the payout for the special game by having the prescribed condition realized by the less number of rearranged scatter symbols than the slot machine 10 for which the rearrangement probability for the scatter symbols is high, so that it has a higher gambling thrill.

It is also possible to make the prescribed condition such that it is realized by a specific pattern, rather than by the scatter symbols. Namely, in the unit game during a period of the free game, points will be generated when symbols are rearranged in a specific pattern on a payline that is set in the partitioned regions q11 to q53, and when these points reach a predetermined number of points, it is regarded that the prescribed condition is realized.

Here, the specific pattern can be the winning combination. This winning combination can be a combination in which the specific symbol (“character #1 (a face of a young male fighter)” of FIG. 7, for example) is rearranged in a region on the payline of the partitioned regions q11 to q53, similarly as in the case of the scatter symbol, for example. In that case, the slot machine 10 in which the number of the specific symbols (the symbol “character #1 (a face of a young male fighter)”) laid out on the circumferential face of each of the rotation reels 53a to 53e of FIG. 7 is greater will have a higher probability for having the specific symbol rearranged on the payline. On the other hand, the slot machine 10 in which the number of the specific symbols laid out on the circumferential face of each of the rotation reels 53a to 53e is less will have a lower probability for having the specific symbol rearranged on the payline.

At the slot machine 10 for which the probability for having the specific symbol rearranged on the payline is high, it becomes easier to realize the winning combination using the specific symbol on the payline in the unit game. In contrast, at the slot machine 10 for which the probability for having the specific symbol rearranged on the payline is low, it becomes harder to realize the winning combination using the specific symbol on the payline in the unit game. For this reason, it is possible to set the points generated when the winning combination using the specific symbol is realized to be a relatively lower value at the slot machine 10 for which the probability for having the specific symbol rearranged on the payline is high, than at the slot machine 10 for which the probability for having the specific symbol rearranged on the payline is low, for example.

When the points are set in this manner, at the slot machine 10 for which the probability for having the specific symbol rearranged on the payline is high, the prescribed condition for obtaining the payout for the special game will be realized by having the winning combination using the specific symbol, that is rather easy to realize, realized on the payline in a large number of the unit games, and accumulating the points in a lower value gradually until they reach the predetermined number of points. On the other hand, at the slot machine 10 for which the probability for having the specific symbol rearranged on the payline is low, the prescribed condition will be realized by having the winning combination using the specific symbol, that is rather hard to realize, realized even in a small number of the unit games, and getting the points in a higher value sporadically until they reach the predetermined number of points.

For this reason, the slot machine 10 for which the probability for having the specific symbol rearranged on the payline is low can obtain the payout for the special game by having the prescribed condition realized by the less number of times for realizing the winning combination using the specific symbol on the payline than the slot machine 10 for which the probability for having the specific symbol rearranged on the payline is high, so that it has a higher gambling thrill.

In this way, in either one of the prescribed condition by the scatter symbols and the prescribed condition by the specific pattern described above, the gambling thrill regarding the payout for the special game will be changed depending on a level of the rearrangement probability of the specific symbol. Then, this specific symbol is displayed on the foot display 34.

For this reason, in the case where the slot machines 10, 10A and 10B, that are sharing the jackpot managed by the common payout controller 3 as the payout resources for the free game, are using symbols with mutually different rearrangement probabilities as the respective specific symbols, as shown in FIG. 8, for example, it becomes possible for a player to recognize the rearrangement probability of the specific symbol in advance according to the content of the specific symbol displayed on the foot display 34.

In this way, it becomes possible for a player to comprehend whether the gambling thrill regarding the payout for the special game is high or low at each of the slot machines 10, 10A and 10B, before playing the game.

Consequently, according to the present invention, it becomes possible to realize the superior entertainment quality as the gaming machine, by enabling a player to play the game by selecting a gaming machine having the gambling thrill that suits his own preference, from a plurality of gaming machines representatively exemplified by the slot machines 10, 10A and 10B which share the payout resources for the special game, that is representatively exemplified by the jackpot.

Note that, at the slot machines 10, 10A and 10B of FIG. 8 described above as one example of the gaming machine of the present invention, when the prescribed condition is set as that of the scatter symbols, the difference in the gambling thrill regarding the payout for the special game arises due to the rearrangement probability of the specific symbol that is set as the scatter symbol. However, a rate by which the unit games in which the predetermined number of the scatter symbols are rearranged occur during the period of the special game is equal regardless of whether the rearrangement probability of the specific symbol that is set as the scatter symbol is high or low. In other words, the probability by which the payout for the special game is obtained as the prescribed condition is realized during the period of the special game is equal regardless of whether the rearrangement probability of the specific symbol that is set as the scatter symbol is high or low.

Similarly, at the slot machines 10, 10A and 10B of FIG. 8 described above as one example of the gaming machine of the present invention, when the prescribed condition is set as that of the specific pattern, the difference in the gambling thrill regarding the payout for the special game arises due to the rearrangement probability of the specific symbol that constitutes the specific pattern. However, a rate by which the points reach the predetermined number of points during the period of the special game due to the realization of the specific pattern is equal regardless of whether the rearrangement probability of the specific symbol is high or low. In other words, the probability by which the payout for the special game is obtained as the prescribed condition is realized during the period of the special game is equal regardless of whether the rearrangement probability of the specific symbol is high or low.

Consequently, according to the gaming machine of the present invention as representatively exemplified by the slot machines 10, 10A and 10B described above, a plurality of gaming machine, for which the rearrangement probability for the specific symbol that influences the possibility of realizing the prescribed condition is mutually different, and hence the gambling thrill regarding the payout for the special game is mutually different, can be made to share the payout resources for the special game that is representatively exemplified by the jackpot, at the equal payout probability.

Next, the detail of the slot machine according to the first embodiment of the present invention will be described. As shown in FIG. 4, the slot machine 10 of this embodiment has the cabinet 11, a top box 12 arranged on an upper side of the cabinet 11, and a main door 13 provided on a front face of the cabinet 11. On a front side of the main door 13, the display 16 is provided. This display 16 has the 15 partitioned regions q11 to q53 arranged in a matrix shape formed by first to fifth columns and first to third rows as shown in FIG. 3.

On this display 16, windows 16a to 16e to be always transparently displayed are provided in correspondence to the first to fifth columns, as shown in FIG. 4. Then, inside the cabinet 11, a rotation reel device 53 is arranged to be located behind the display 16.

The rotation reel device 53 has five rotation reels 53a to 53e corresponding to the windows 16a to 16e of the display 16, as shown in FIG. 6A. Also, as shown in FIG. 6B, the rotation reel device 53 has driving motors 56a to 56e formed by stepping motors to rotate the rotation reels 53a to 53e, respectively. Also, the rotation reel device 53 has sensors 54a to 54e (see FIG. 5) for reading a bar code and counting a number of slits that have passed, in order to detect a rotation, a stopping, and a stopped rotation position of each of the rotation reels 53a to 53e.

On a circumferential face of each of the rotation reels 53a to 53e, 21 symbols are laid out at equal intervals, as shown in FIG. 7. More specifically, on the rotation reels 53a to 53e, nine types of symbols including “A (Ace card)”, “K (King card)”, “Q (Queen card)”, “J (Jack card)”, “10 (10 card)”, “Umbrella”, “Lightning”, “Cloud”, and “character #1 (a face of a young male fighter)” are laid out in prescribed patterns.

In the slot machine 10 of this embodiment, as shown in FIG. 4, three consecutive symbols among 21 symbols laid out on the circumferential face of the corresponding one of the rotation reels 53a to 53e can be made visible to a player, through each of the windows 16a to 16e of the display 16. In other words, the windows 16a to 16e of the display 16 constitute the corresponding three partitioned regions q11 to q13, q21 to q23, q31 to q33, q41 to q43, and q51 to q53 in the row direction on the first to fifth columns.

Then, in the slot machine 10 of this embodiment, a single play of the slot game (unit game) is executed by rearranging symbols arranged in the partitioned regions q11 to q53 and visible to a player through the windows 16a to 16e by rotation and stopping of the rotation reels 53a to 53e. Normally, it becomes possible to execute this slot game by making bets using gaming medium, but as will be described below, it is possible to execute the slot game without making any bets during a period of a free game that will be executed for the purpose of determining the payout of the jackpot in conjunction with a notification from a payout controller (see FIG. 8).

Note that, in this embodiment, an exemplary case of using medals as the gaming medium to be used at a time of executing the slot game (except for a period of a free game) is described, but the gaming medium for the slot game is not limited to the medals, and can be medals, tokens, electronic money, or electronic value information (credit) corresponding to these.

On the lower side of the display 16, various types of input buttons 23 to 27 through which commands related to the proceeding of the game will be inputted by a player, a medal insertion slot 21 for accepting medals, and a bill validator 22 for checking the validity of bills and accepting valid bills are provided. Note that the bill validator 22 may be configured such that it can read a bar code attached ticket 39.

Also, in a vicinity of these medal insertion slot 21 and bill validator 22, various types of operation switches are provided. As the operation switches, a payout switch 23, a MAXBET switch 24, a BET switch 25, a spin repeat bet switch 26, and a start switch 27 are provided.

The BET switch 25 is a switch for determining the credit amount to be bet with respect to the slot game to be executed on the display 16, where the credit of one medal will be bet every time the BET switch 25 is pressed, as will be described below.

The spin repeat bet switch 26 is for executing the slot game by betting the credit again without changing the credit amount bet by the BET switch 25 described above in a previous game.

The start switch 27 is a switch for starting the slot game after the desired amount of credit is bet. When this start switch 27 is pressed after either medals are inserted into the medal insertion slot 21 or the credit is bet by the BET switch 25, the slot game will be started on the display 16.

The payout switch 23 is a switch for having the inserted medals paid out, and the medals to be paid will be ejected from a medal payout opening 19 that is opening at a lower front side of the main door 13, and the paid medals will be accumulated in a medal tray 18.

The MAXBET switch 24 is a switch for betting the maximum amount of credit (30 medals, for example) that can be bet in a single play of the slot game, by a single operation.

On the lower front face of the main door 13, a foot display 34 is provided, which displays a prescribed image according to an image display control data contained in a currently executed game software. In this embodiment, a symbol “character #1 (a face of a young male fighter)” which is a specific symbol in this slot machine 10 will be displayed on the foot display 34 as the prescribed image.

The symbol “character #1 (a face of a young male fighter)” displayed on the foot display 34 will become a target symbol to be counted in order to determine the payout credit amount of the jackpot in the slot game executed during a period of a free game.

On a front face of the top box 12, an upper display 33 is provided. The upper display 33 has a liquid crystal panel, which displays the payout table and the like.

Also, on the top box 12, a speaker 29 is provided. On a lower side of the upper display 33, a ticket printer 35, a card reader 36, a data display 37, and a key pad 38 are provided. The ticket printer 35 prints a bar code, in which data such as the credit amount, the date and time, the identification number of the slot machine 10, etc. are encoded, on a ticket, and outputs it as the bar code attached ticket 39.

A player can make the bar code attached ticket 39 read at another slot machine, and use it as bets at a time of playing the slot game at that slot machine or exchange the bar code attached ticket 39 to bills and the like at a prescribed location in a gaming facility (a cashier in the casino, for example).

The card reader 36 is capable of having a smart card inserted therein, and carrying out a reading of data from the inserted smart card and a writing of data into the smart card. The smart card is a card to be carried around by a player, which stores data for identifying a player and data regarding a log of games played by a player.

The smart card may also store data corresponding to coins, bills, or credit. Also, instead of the smart card, a magnetic stripe card may be adopted. The data display 37 is formed by :a fluorescent- display or the like, and displays data read by the card reader 36 and data inputted by a player through the key pad 38, for example.

Also, instead of the smart card, an RFID scheme may be adopted and a card to/from which data can be written/read in a non-contact manner may be used. The key pad 38 is for inputting commands and data regarding a ticket issuance and the like.

FIG. 5 is a block diagram showing a control circuit of the slot machine according to this embodiment. In the figure, a controller 40 is a micro-computer, which has an interface circuit group 102, an input/output bus 104, a CPU 106, a ROM 108, a RAM 110, a communication interface circuit 111, a random number generator 112, a speaker driving circuit 122, a hopper driving circuit 124, a display driving circuit 128, display controllers 140 and 141, a motor driving circuit 51 for driving the driving motors 56a to 56e of the rotation reel device 53, and a reel position detection circuit 52 for detecting a rotation, a stopping, and a stopped position of each of the rotation reels 53a to 53e according to outputs of the sensors 54a to 54e of the rotation reel device 53.

The sensors 54a to 54e are arranged to be facing with margin portions 55 secured adjacent to symbol layout regions on the circumferential faces of the corresponding rotation reels 53a to 53e. Then, each of the sensors 54a to 54e can detect a rotation, a stopping, and a stopped position of each of the rotation reels 53a to 53e by detecting an identifier such as a bar code laid out in the margin portion 55 in correspondence to each symbol. Note that, for the detection of the identifier by the sensors 54a to 54e, various types of known schemes such as an optical one or a magnetic one can be utilized.

The interface circuit group 102 is connected to the input/output bus 104, and this input/output bus 104 carries out input/output of data signals or address signals with respect to the CPU 106.

To the interface circuit group 102, the start switch 27 is connected. A start signal outputted from this start switch 27 is converted into a prescribed signal at the interface circuit group 102, and then transmitted to the CPU 106 through the input/output bus 104.

In addition, to the interface circuit group 102, the BET switch 25, the MAXBET switch 24, the spin repeat bet switch 26 and the payout switch 23 are connected. Then, the switching signals outputted from these switches 25, 24, 26 and 23 are supplied to the interface circuit group 102, converted into prescribed signals at this interface circuit group 102, and then transmitted to the CPU 106 through the input/output bus 104.

Moreover, to the interface circuit group 102, a medal sensor 43 is connected. The medal sensor 43 is a sensor for detecting medals inserted at the medal insertion slot 21, which is provided at a medal insertion portion of the medal insertion slot 21. A detection signal outputted from this medal sensor 43 is supplied to the interface circuit group 102, converted into a prescribed signal at this interface circuit group 102, and then transmitted to the CPU 106 through the input/output bus 104.

To the input/output bus 104, the ROM 108 for storing a system program and the RAM 110 for storing various types of data are connected. In the RAM 110, areas and the like for managing flags and storing various types of information are provided.

In the ROM 108, the payout table is stored. The payout table indicates a condition for generating the payout, and its correspondence relationship with the credit payout amount in the case where this condition is satisfied. The condition for generating the payout is determined according to contents of symbols rearranged in the partitioned regions q11 to q53 of the display 16. The rearrangement contents of symbols to become targets for generating the payout can be determined by the number of scatter symbols rearranged or a pattern of a winning combination realized on a payline that is set on the partitioned regions q11 to q53, in the slot game. In the slot game of this embodiment, the CPU 106 determines whether or not to generate the payout (whether or not to make the credit payout) and the credit payout amount (an amount of credit to be paid), according to the payout table and the symbols stopped at the partitioned regions q11 to q53.

Note that a payout table for determining the payout credit amount of the jackpot in the slot game executed during a period of a free game is stored in a payout controller 3 (see FIG. 8) to be described below.

The CPU 106 reads out a game execution program from the ROM 108 and executes the slot game, at a timing when a start operation of the game is accepted by the start switch 27. The game execution program is a program for executing the slot game by driving the driving motors 56a to 56e of the rotation reel device 53 through the motor driving circuit 51.

Namely, as a program for executing the slot game, the game execution program is programmed to execute the slot game such that symbols are displayed as dynamically changing simultaneously in the partitioned regions q11 to q53 of the display 16, and then symbols are stopped, and the credit of the payout amount according to the payout table stored in the ROM 108 is paid when symbols in contents which are a target for generating the payout are rearranged.

In addition, to the input/output bus 104, the random number generator 112, the communication interface circuit 111, the display controllers 140 and 141, the hopper driving circuit 124, the speaker driving circuit 122, the display driving circuit 128, the motor driving circuit 51, and the reel position detection circuit 52 are connected.

The communication interface circuit 111 is connected to a hall server or the like, and transmits data on a play log executed at this slot machine 10 and the like to the hall server. It also receives various types of data transmitted from the hall server.

The random number generator 112 generates a random number for determining whether or not to generate a winning combination or a jackpot in the slot game executed on the display 16.

The display driving circuit 128 carries out a control for displaying the payout amount on a payout display region 48 provided on a lower left region of the display 16.

The speaker driving circuit 122 outputs speech data to the speaker 29. Namely, the CPU 106 reads out the speech data stored in the ROM 108, and transmit this speech data to the speaker driving circuit 122 through the input/output bus 104. In this way, a prescribed effect sound will be generated from the speaker 29.

The hopper driving circuit 124 outputs a payout signal to the hopper 44 when the payout is generated. Namely, when a payout signal is inputted by the payout switch 23, the CPU 106 outputs a driving signal to the hopper driving circuit 124 through the input/output bus 104. In this way, the hopper 44 pays medals corresponding to the remaining amount of credit at that moment which is stored in a prescribed memory region of the RAM 110.

The display controller 140 carries out a display control for making the windows 16a to 16e to always transparently display. Namely, the CPU 106 generates an image display command signal for making the windows 16a to 16e to always transparently display, and outputs this image display command signals to the display controller 140 through the input/output bus 104. When the image display command signal outputted from the CPU 106 is inputted, the display controller 140 generates a driving signal for driving the display 16 according to this image display command, and outputs this generated driving signal to the display 16. In this way, the windows 16a to 16e will be always transparently displayed on the display 16.

The display controller 141 carries out a control for displaying the symbol “character #1 (a face of a young male fighter)” that is the specific symbol, on the foot display 34. Namely, the CPU 106 generates an image display command signal according to the symbol “character #1 (a face of a young male fighter)”, and outputs this image display command signals to the display controller 141 through the input/output bus 104. When the image display command signal outputted from the CPU 106 is inputted, the display controller 141 generates a driving signal for driving the foot display 34 according to this image display command, and outputs this generated driving signal to the foot display 34. In this way, the symbol “character #1 (a face of a young male fighter)” will be displayed on the foot display 34. This display can be made in a form of a still image or a dynamic image.

The slot machine 10 of FIG. 4 having the configuration described above is arranged on the stage 1, along with the other two slot machines 10A and 10B, as shown in FIG. 8. In this stage 1, the payout controller 3 is accommodated. This payout controller 3 manages the jackpot. This jackpot is shared as the payout resources for the free game at the three slot machines 10, 10A and 10B on the stage 1.

Two slot machines 10A and 10B arranged on the stage 1 along with the slot machine 10 have basically the same configuration as the slot machine 10. However, the contents and patterns of symbols laid out on the rotation reels 53a to 53e, a content of a symbol displayed on the foot display 34, and a content of the payout table stored in the ROM 108 are different from the slot machine 10.

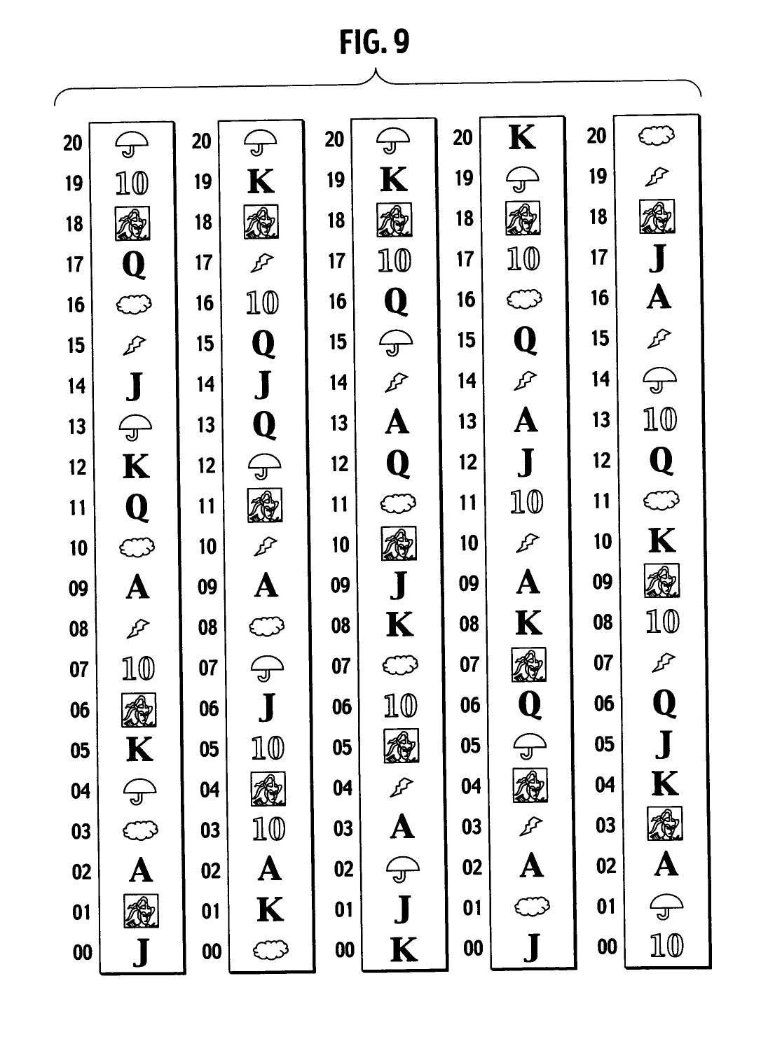

On a circumferential face of each of the rotation reels 53a to 53e of the slot machine 10A, 21 symbols are laid out at equal intervals, as shown in FIG. 9. More specifically, on the rotation reels 53a to 53e, nine types of symbols including “A (Ace card)”, “K (King card)”, “Q (Queen card)”, “J (Jack card)”, “10 (10 card)”, “Umbrella”, “Lightning”, “Cloud”, and “character #2 (a face of a young female fighter)” are laid out in prescribed patterns.

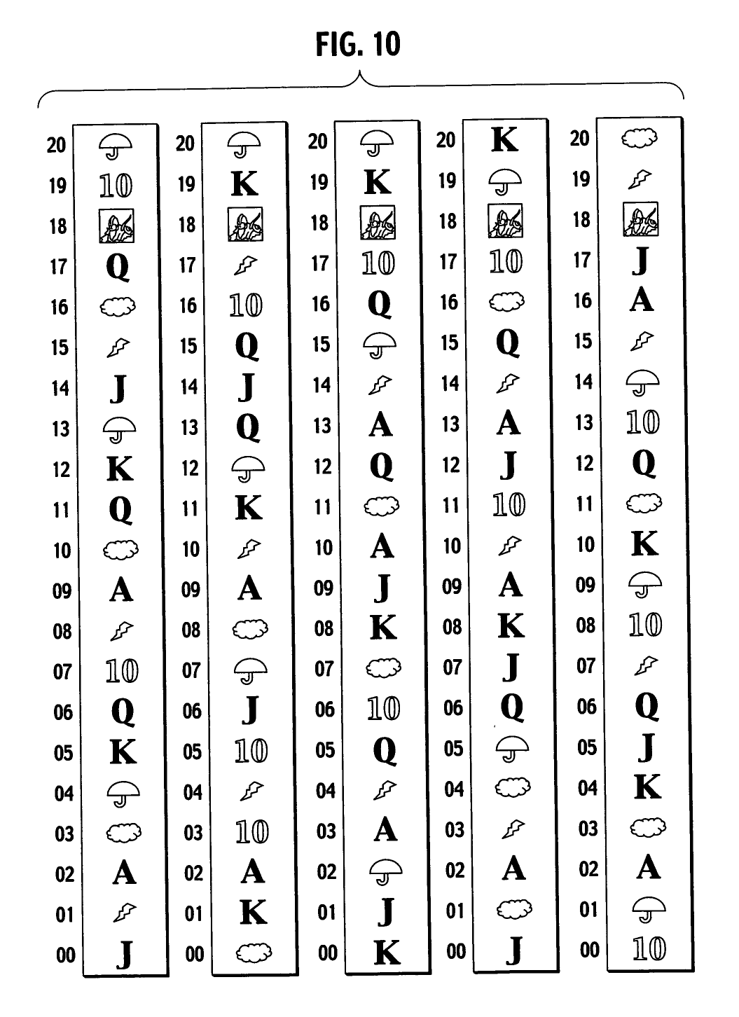

Also, on a circumferential face of each of the rotation reels 53a to 53e of the slot machine 10B, 21 symbols are laid out at equal intervals, as shown in FIG. 10. More specifically, on the rotation reels 53a to 53e, nine types of symbols including “A (Ace card)”, “K (King card)”, “Q (Queen card)”, “J (Jack card)”, “10 (10 card)”, “Umbrella”, “Lightning”, “Cloud”, and “character #3 (a face of a mature male fighter)” are laid out in prescribed patterns.

On the foot display 34 of the slot machine 10A, a symbol “character #2 (a face of a young female fighter)” will be displayed as the prescribed image, according to an image display control data contained in a currently executed game software. This symbol “character #2 (a face of a young female fighter)” will become a target symbol to be counted in order to determine the payout credit amount of the jackpot in the slot game executed at the slot machine 10A during a period of a free game.

Also, on the foot display 34 of the slot machine 10B, a symbol “character #3 (a face of a mature male fighter)” will be displayed as the prescribed image, according to an image display control data contained in a currently executed game software. This symbol “character #3 (a face of a mature male fighter)” will become a target symbol to be counted in order to determine the payout credit amount of the jackpot in the slot game executed at the slot machine 10B during a period of a free game.

Consequently, the display controller 141 of the slot machine 10A or the slot machine 10B (see FIG. 5) respectively carries out a control for displaying the symbol “character #2 (a face of a young female fighter)” or the symbol “character #3 (a face of a mature male fighter)” that is the specific symbol, on the foot display 34. Namely, the respective CPU 106 generates an image display command signal according to the symbol “character #2 (a face of a young female fighter)” or the symbol “character #3 (a face of a mature male fighter)”, and outputs this image display command signals to the display controller 141 through the input/output bus 104.

When the image display command signal outputted from the CPU 106 is inputted, the display controller 141 generates a driving signal for driving the foot display 34 according to this image display command, and outputs this generated driving signal to the foot display 34. In this way, the symbol “character #2 (a face of a young female fighter)” and the symbol “character #3 (a face of a mature male fighter)” will be displayed on the foot displays 34 of the slot machine 10A and the slot machine 10B, respectively. These displays can be made in forms of still images or dynamic images.

The payout table stored in the ROM 108 of the slot machine 10A or the slot machine 10B basically has the same configuration as the payout table stored in the ROM 108 of the slot machine 10. However, the types and layout pattern of symbols laid out on the rotation reels 53a to 53e are different for the slot machine 10A or the slot machine 10B and the slot machine 10. Consequently, the payout table stored in the respective ROM 108 of the slot machine 10A or the slot machine 10B has contents of a condition for generating the payout and its correspondence relationship with the credit payout amount in the case where this condition is satisfied, that are different from those of the payout table stored in the ROM 108 of the slot machine 10.

Note that, as shown in FIG. 7, the symbol “character #1 (a face of a young male fighter)” that is the specific symbol at the slot machine 10 is laid out such that this symbol appears twice on each of the circumferential face of each of the rotation reels 53a to 53e. In contrast, as shown in FIG. 9, the symbol “character #2 (a face of a young female fighter)” that is the specific symbol at the slot machine 10A is laid out such that this symbol appears three times on each of the circumferential face of each of the rotation reels 53a to 53e. Also, as shown in FIG. 10, the symbol “character #3 (a face of a mature male fighter)” that is the specific symbol at the slot machine 10B is laid out such that this symbol appears once on each of the circumferential face of each of the rotation reels 53a to 53e.

Consequently, at the slot machines 10, 10A and 10B, the probability by which the specific symbol is rearranged in each of the partitioned regions q11 to q13, q21 to q23, q31 to q33, q41 to q43 and q51 to q53 on columns is higher for the slot machine 10A than the slot machine 10, and lower for the slot machine 10B than the slot machine 10.

For this reason, the symbols “character #1 (a face of a young male fighter)”, “character #2 (a face of a young female fighter)”, and “character #3 (a face of a mature male fighter)” displayed on the respective foot displays 34 of the slot machines 10, 10A and 10B can be regarded as indicating the levels of the rearrangement probability of the specific symbol at the respective slot machines 10, 10A and 10B.

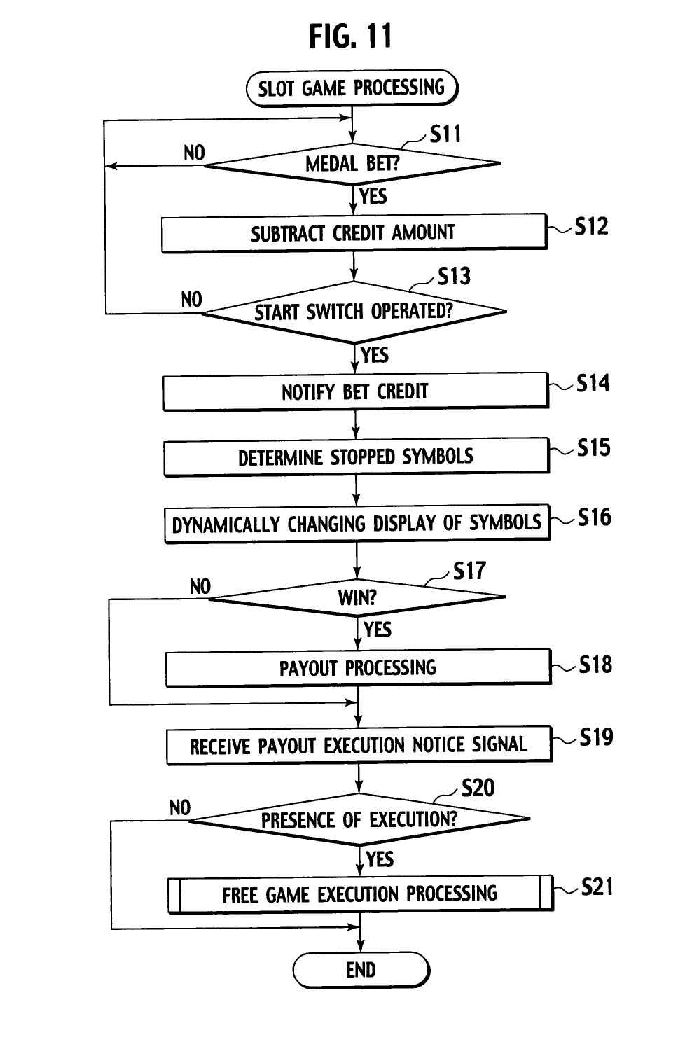

Next, with references to the flow charts shown in FIG. 11 to FIG. 13, the operation common to the slot machines 10, 10A and 10B will be described. FIG. 11 to FIG. 13 are flow chars showing procedures of the slot game processing and the free game execution processing, which are to be carried out by the CPU 106 shown in FIG. 5 according to the game execution program stored in the ROM 108.

First, when it is entered into the slot game processing shown in FIG. 11, the CPU 106 judges whether the credit is bet or not at the step S11. In this processing, the CPU 106 judges whether or not either a signal outputted from the BET switch 25 as the BET switch 25 is pressed or a signal outputted from the MAXBET switch 24 as the MAXBET switch 24 is pressed is received. When it is judged that the credit is not bet, the processing is returned to the step S11.

On the other hand, when it is judged that the credit is bet at the step S11, the CPU 106 proceeds to the step S12, and subtracts the credit amount stored in the RAM 11 according to the bet credit amount.

Next, at the step S13, the CPU 106 judges whether the start switch 27 is pressed or not. In this processing, the CPU 106 judges whether or not a signal outputted from the start switch 27 as the start switch 27 is pressed is received.

When it is judged that the start switch 27 is not pressed, the CPU 106 returns the processing to the step S11. Note that, when the start switch 27 is not pressed (a case where a command for finishing the game is inputted without pressing the start switch 27, for example), the CPU 106 cancels the subtraction result of the credit amount at the step S12.

Then, when it is judged that the start switch 27 is pressed at the step S13, the CPU 106 proceeds from the step S13 to the step S14, and notifies the bet credit amount to the payout controller 3. Along with that, at the step S15, the CPU 106 determines the stopped symbols. In this stopped symbol determination processing, the CPU 106 determines symbols to be displayed as stopping (rearranged) in the partitioned regions q11 to q53 by executing a stopped symbol determination program which is one of the game execution program stored in the ROM 108.

By this stopped symbol determination processing, a symbol to be rearranged in each of the partitioned regions q11 to q53 on the first to fifth columns shown in FIG. 3 is determined to be one of nine types of symbols shown in FIG. 7 including “A (Ace card)”, “K (King card)”, “Q (Queen card)”, “J (Jack card)”, “10 (10 card)”, “Umbrella”, “Lightning”, “Cloud”, and “character #1 (a face of a young male fighter” at the slot machine 10.

Similarly, at the slot machine 10A, it is determined to be one of nine types of symbols in which the symbol “character #1 (a face of a young male fighter” is changed to the symbol “character #2 (a face of a young female fighter” as shown in FIG. 9. Also, at the slot machine 10B, it is determined to be one of nine types of symbols in which the symbol “character #1 (a face of a young male fighter” is changed to the symbol “character #3 (a face of a mature male fighter” as shown in FIG. 10.

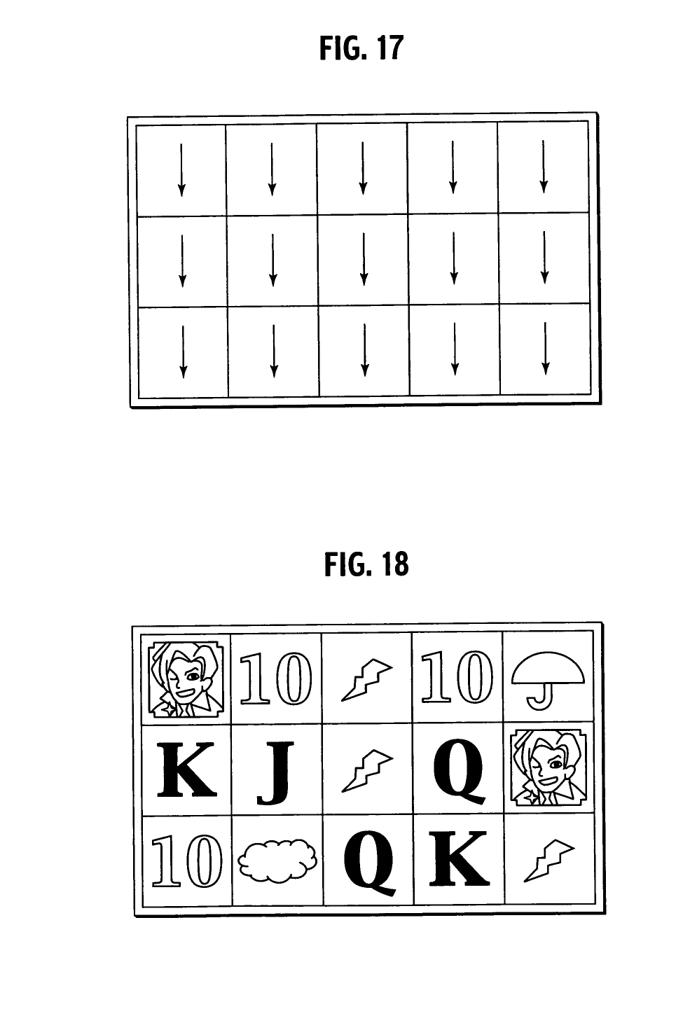

Next, the CPU 106 carries out the symbol dynamically changing display processing at the step S16. This processing is a processing for starting display of symbols as dynamically changing in the partitioned regions q11 to q53 as shown in FIG. 17, and then stopping the symbols in the partitioned regions q11 to q53 as shown in FIG. 18. By this processing for starting and stopping the dynamically changing display, symbols are rearranged in the partitioned regions q11 to q53. The processing for the dynamically changing display of symbols at the step S16 is carried out by rotating and stopping the rotation reels 53a to 53e of the rotation reel device 53 by driving the driving motors 56a to 56e by the motor driving circuit 51.

When the dynamically changing display processing is finished, the CPU 106 proceeds to the step S17, and judges whether there is a win or not according to the symbols rearranged in the partitioned regions q11 to q53. Namely, the CPU 106 judges whether a condition for generating a prize is satisfied or not.

At this step S17, the CPU 106 judges whether or not the contents of the symbols rearranged at the step S16 described above are coinciding with any of the symbol rearrangement contents set in the payout table as targets for generating the payout, by referring to the payout table stored in the ROM 108.

Then, when they coincide with the symbol rearrangement contents set in the payout table, the credit payout amount is determined to be the payout amount set in correspondence to that symbol rearrangement contents by regarding that a win is realized, and it proceeds from the step S17 to the next step S18.

On the other hand, when the contents of the symbols rearranged at the step S16 described above do not coincide with any of the symbol rearrangement contents that are the payout generation targets set in the payout table, the CPU106 proceeds the processing to the step S19 to be described below by regarding that a win is not realized.

At the step S18, the CPU 106 executes a payout processing for paying the credit according to a result of the win at the step S16 described above. In this payout processing, the CPU 108 adds the credit payout amount generated at the step S17 described above to the credit amount stored in the RAM 110.

At the step S19, the CPU 106 receives a payout execution notice signal from the payout controller 3 to be described below which notifies presence or absence of the jackpot payout execution. Then, at the step S20, the CPU 106 judges whether the content of the received payout execution notice signal is the presence of the execution or not.

In the case where the content of the received payout execution notice signal is not the presence of the execution (it is the absence of the execution) (step S20 NO), the CPU 106 returns to the step S11 described above, and executes the next slot game processing. In the case where the content of the received payout execution notice signal is the presence of the execution (step S20 YES), after carrying out the free game execution processing at the step S21, the CPU 106 returns to the step S11 described above, and executes the next slot game processing.

In the free game execution processing of the step S21, the CPU 106 can execute two types of processing. One of them is for executing the slot game with the specific symbol as the scatter symbol, for the prescribed number of times (20 times in this embodiment) during the free game period. The other one is for executing the slot game with a combination using the specific symbol as the winning combination, for the prescribed number of times during the free game period.

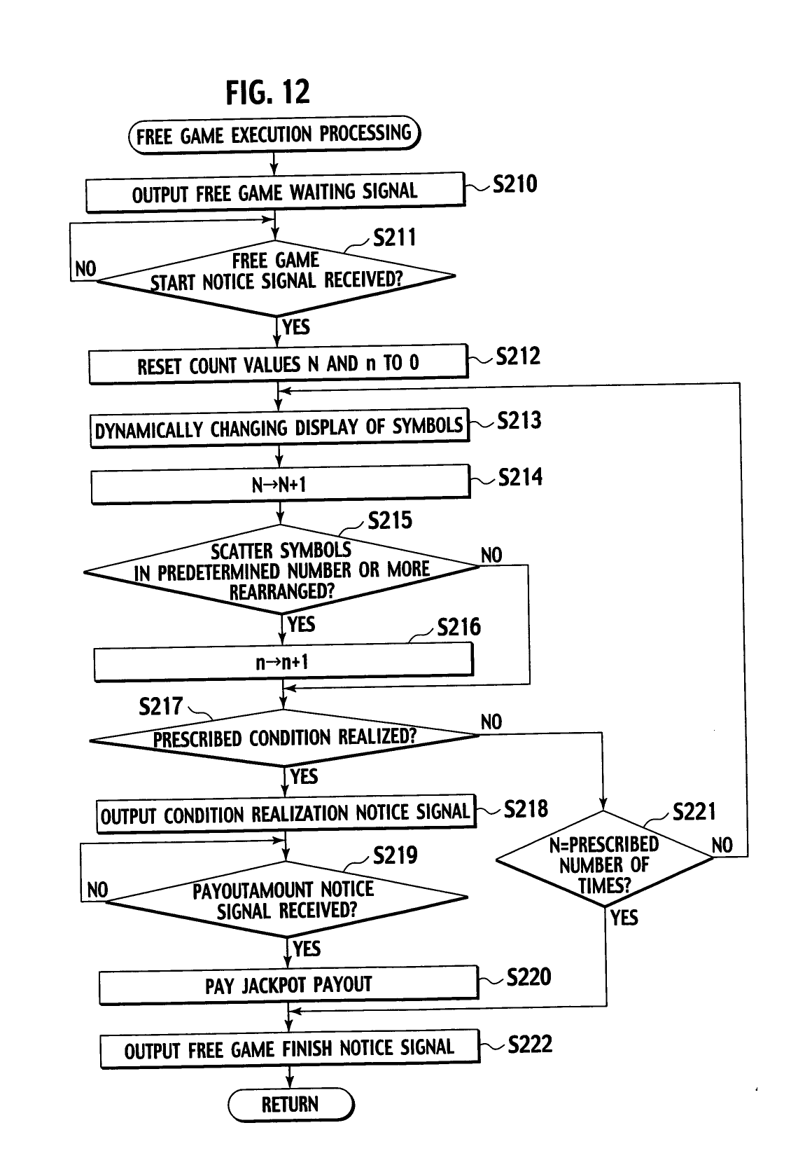

Here, the free game execution processing in the case of executing the slot game with the specific symbol as the scatter symbol for the prescribed number of times during the free game period will be described first with reference to FIG. 12.

First, as shown in FIG. 12, at the step S210, the CPU 106 outputs a free game waiting signal to the payout controller 3. Then, the CPU 106 waits for receiving a free game start notice signal from the payout controller 3 (step S211). Then, when the free game start notice signal is received (step S211 YES), the CPU 106 resets a count value N of a free game counter and a count value n of a predetermined game number counter that are provided in the RAM 110 to zero (step S212). In addition, at the step S213, the CPU 106 carries out the symbol dynamically changing display processing similar to the step S16 of FIG. 11.

Next, at the step S214, the CPU 106 increments the count value N of the free game counter in the RAM 110 by “1”, and at the next step S215, the CPU 106 judges whether the scatter symbols in a number greater than or equal to the predetermined number are rearranged in the partitioned regions q11 to q53 or not.

Here, the scatter symbol is the specific symbol in each of the slot machines 10, 10A and 10B. Namely, the symbol “character #1 (a face of a young male fighter)” is the scatter symbol at the slot machine 10, the symbol “character #2 (a face of a young female fighter)” is the scatter symbol at the slot machine 10A, and the symbol “character #3 (a face of a mature male fighter)” is the scatter symbol at the slot machine 10B.

Also, a value of the predetermined number can be set higher for any of the slot machines 10, 10A and 10B for which the number of the specific symbols laid out on the circumferential face of each of the rotation reels 53a to 53e is greater. In this embodiment, the value of the predetermined number is set to the highest value “5” at the slot machine 10A for which the symbol “character #2 (a face of a young female fighter)” that is laid out three times on the circumferential face of each of the rotation reels 53a to 53e is the specific symbol. Also, the value of the predetermined number is set to the lowest value “1” at the slot machine 10B for which the symbol “character #3 (a face of a mature male fighter)” that is laid out once on the circumferential face of each of the rotation reels 53a to 53e is the specific symbol. Then, the value of the predetermined number is set to the middle value “3” at the slot machine 10 for which the symbol “character #1 (a face of a young male fighter)” that is laid out twice on the circumferential face of each of the rotation reels 53a to 53e is the specific symbol.

Then, in the case where the scatter symbols (specific symbols) in a number greater than or equal to the predetermined number are rearranged in the partitioned regions q11 to q53 (step S215 YES), the count value n of the predetermined game number counter in the RAM 110 is incremented by “1” (step S216), and the processing proceeds to the step S217. Also, in the case where the scatter symbols (specific symbols) in a number greater than or equal to the predetermined number are not rearranged in the partitioned regions q11 to q53 (step S215 NO), the processing proceeds to the step S217.

At the step S217, the CPU 106 judges whether the prescribed condition that is a condition for executing the payment of credit as the payout for the free game is realized or not. This judgment can be made by judging whether the count value n of the predetermined game number counter in the RA 110 has reached the predetermined game number (“3” in this embodiment) or not. Note that it is also possible to make it such that the predetermined game number is specified from the payout controller 3 in the free game start notice signal received at the step S211, for example.

In the case where the prescribed condition is realized (step S217 YES), the CPU 106 outputs a condition realization notice signal to the payout controller 3 (step S218), and waits for a payout amount notice signal from the payout controller 3 (step S219). Then, when the payout amount notice signal is received (step S219 YES), the CPU 106 pays the credit amount specified in the received payout amount notice signal as the payout from the jackpot (step S220). Note that there are cases where the credit amount specified in the payout amount notice signal is “0”. Then, the CPU 106 proceeds the processing to the step S222 to be described below.

Also, in the case where the prescribed condition is not realized (step S217 NO), at the step S221, the CPU 106 judges whether the count value N of the free game counter in the RAM 110 has reached the prescribed number of times (20 times in this embodiment), that is the number of the slot games to be executed during the free game period, or not.

In the case where the count value N of the free game counter has not reached the prescribed number of times (step S221 NO), the CPU 106 proceeds the processing to the step S213. In the case where the count value N has reached the prescribed number of times (step S221 YES), the CPU 106 proceeds the processing to the step S222.

At the step S222, the CPU 106 outputs a free game finish notice signal (step S222), and then terminates the free game execution processing.

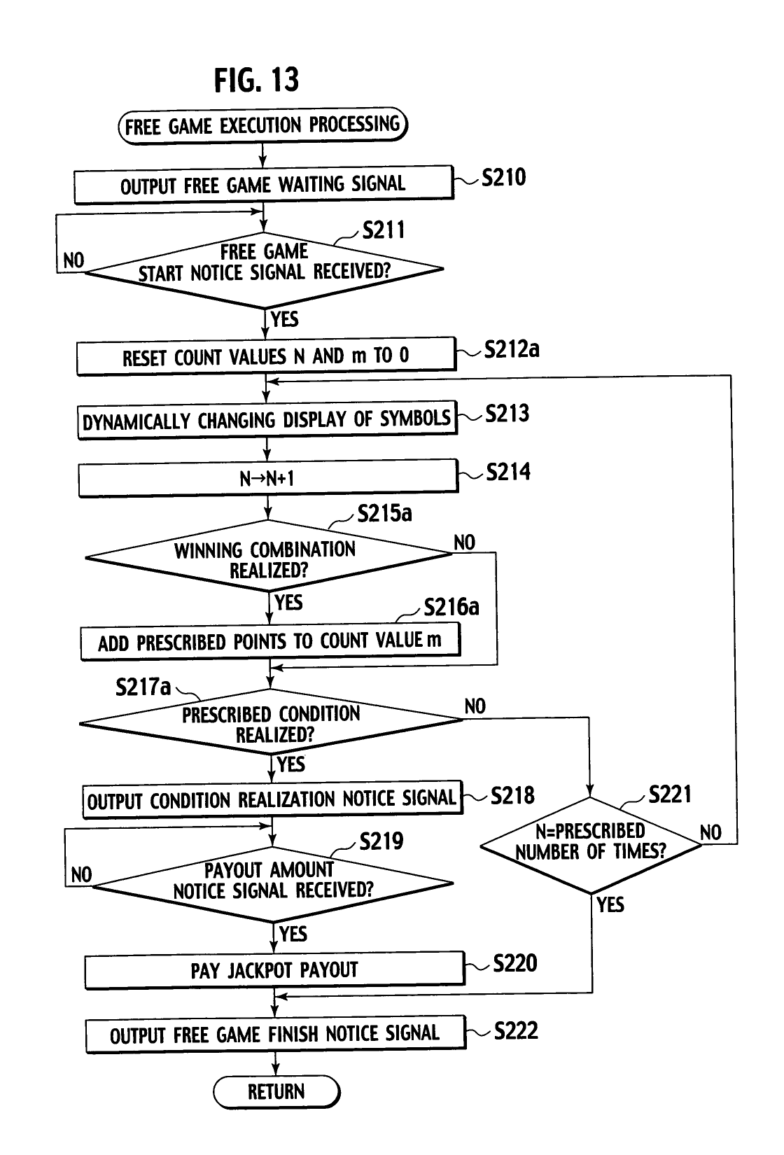

Next, the free game execution processing in the case of executing the slot game with the combination using the specific symbol as the winning combination for the prescribed number of times during the free game period will be described first with reference to FIG. 13.

First, as shown in FIG. 13, at the step S210, the CPU 106 outputs a free game waiting signal to the payout controller 3. Then, the CPU 106 waits for receiving a free game start notice signal from the payout controller 3 (step S211). Then, when the free game start notice signal is received (step S211 YES), the CPU 106 resets a count value N of a free game counter and a count value m of a predetermined point number counter that are provided in the RAM 110 to zero (step S212a). In addition, at the step S213, the CPU 106 carries out the symbol dynamically changing display processing similar to the step S16 of FIG. 11.

Next, at the step S214, the CPU 106 increments the count value N of the free game counter in the RAM 110 by “1”, and at the next step S215a, the CPU 106 judges whether the winning combination is realized on the payline set in the partitioned regions q11 to q53 or not.

Here, the winning combination is a combination using the specific symbol in each of the slot machines 10, 10A and 10B. Namely, it is a combination using the symbol “character #1 (a face of a young male fighter)” at the slot machine 10, it is a combination using the symbol “character #2 (a face of a young female fighter)” at the slot machine 10A, and it is a combination using the symbol “character #3 (a face of a mature male fighter)” at the slot machine 10B.

Then, in the case where the winning combination (the combination using the specific symbol) is realized on the payline (step S215a YES), prescribed points are added to the count value m of the predetermined point number counter (step S216a), and the processing proceeds to the step S217a. Also, in the case where the winning combination is not realized on the payline (step S215a NO), the processing proceeds to the step S217a.

Here, a value of the prescribed points can be set lower for any of the slot machines 10, 10A and 10B for which the number of the specific symbols laid out on the circumferential face of each of the rotation reels 53a to 53e is greater. In this embodiment, the value of the prescribed points is set to the lowest value “1” at the slot machine 10A for which the symbol “character #2 (a face of a young female fighter)” that is laid out three times on the circumferential face of each of the rotation reels 53a to 53e is the specific symbol. Also, the value of the prescribed points is set to the highest value “5” at the slot machine 10B for which the symbol “character #3 (a face of a mature male fighter)” that is laid out once on the circumferential face of each of the rotation reels 53a to 53e is the specific symbol. Then, the value of the prescribed points is set to the middle value “3” at the slot machine 10 for which the symbol “character #1 (a face of a young male fighter)” that is laid out twice on the circumferential face of each of the rotation reels 53a to 53e is the specific symbol.

Then, at the step S217a, the CPU 106 judges whether the prescribed condition that is a condition for executing the payment of credit as the payout for the free game is realized or not. This judgment can be made by judging whether the count value m of the predetermined point number counter has reached the predetermined point number (“15” in this embodiment) or not. Note that it is also possible to make it such that the predetermined point number is specified from the payout controller 3 in the free game start notice signal received at the step S211, for example.

In the case where the prescribed condition is realized (step S217a YES), the CPU 106 outputs a condition realization notice signal to the payout controller 3 (step S218), and waits for a payout amount notice signal from the payout controller 3 (step S219). Then, when the payout amount notice signal is received (step S219 YES), the CPU 106 pays the credit amount specified in the received payout amount notice signal as the payout from the jackpot (step S220). Note that there are cases where the credit amount specified in the payout amount notice signal is “0”. Then, the CPU 106 proceeds the processing to the step S222 to be described below.

Also, in the case where the prescribed condition is not realized (step S217a NO), at the step S221, the CPU 106 judges whether the count value N of the free game counter in the RAM 110 has reached the prescribed number of times (20 times in this embodiment), that is the number of the slot games to be executed during the free game period, or not.

In the case where the count value N of the free game counter has not reached the prescribed number of times (step S221 NO), the CPU 106 proceeds the processing to the step S213. In the case where the count value N has reached the prescribed number of times (step S221 YES), the CPU 106 proceeds the processing to the step S222.

At the step S222, the CPU 106 outputs a free game finish notice signal (step S222), and then terminates the free game execution processing.

As should be apparent from the above description, in this embodiment, the CPU 106 constitutes a machine controller of the claims.

As the CPU 106 executes the free game execution processing of FIG. 12 or FIG. 13 described above, the payouts of the free game to be paid at the slot machines 10, 10A and 10B will have the jackpot managed by the payout controller 3 shown in FIG. 8 as the payout resources, as described above. This payout controller 3 can be formed by a computer having CPU, ROM and RAM.

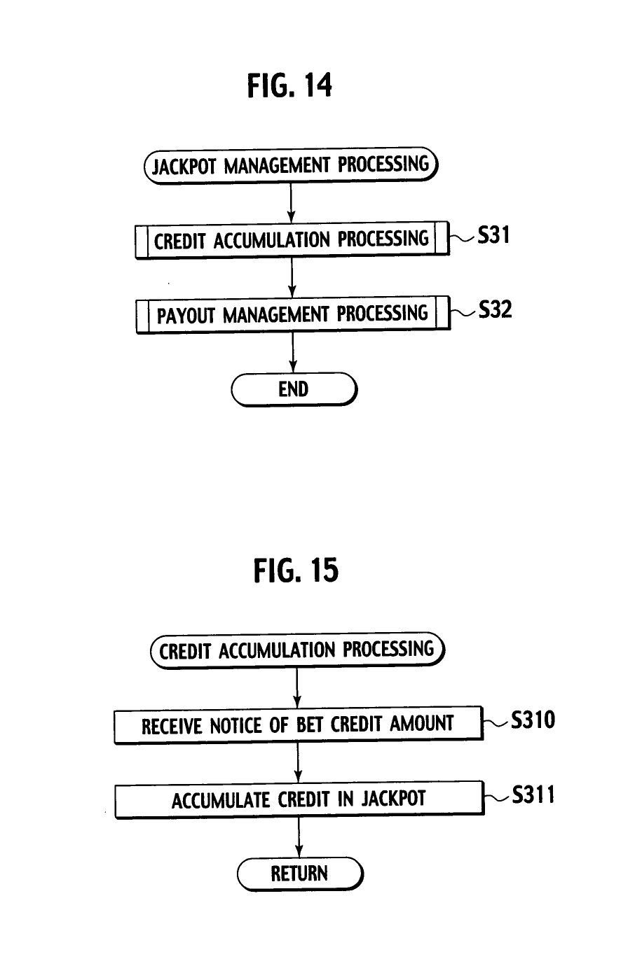

Next, the operation of the payout controller 3 will be described with references to the flow charts shown in FIG. 14 to FIG. 16. FIG. 14 to FIG. 16 are flow charts showing procedures of the jackpot management processing, the credit accumulation processing, and the payout management processing, to be carried out by the payout controller 3 according to programs stored in the ROM.

First, upon entering the jackpot management processing shown in FIG. 14, the payout controller 3 repeatedly executes the credit accumulation processing of the step S31 and the payout management processing of the step S32.

At the credit accumulation processing of the step S31, as shown in FIG. 15, the payout controller 3 receives a notice of the bet credit amount from each of the slot machines 10, 10A and 10B (step S310). Then, the payout controller 3 accumulates the credit amount corresponding to the bet credit amount in the jackpot (step S311). The credit amount to be accumulated in the jackpot can be obtained by multiplying a certain multiplication rate (a value less than 1) to the bet credit amount notified from each of the slot machines 10, 10A and 10B. After that, the payout controller 3 terminates the credit accumulation processing.

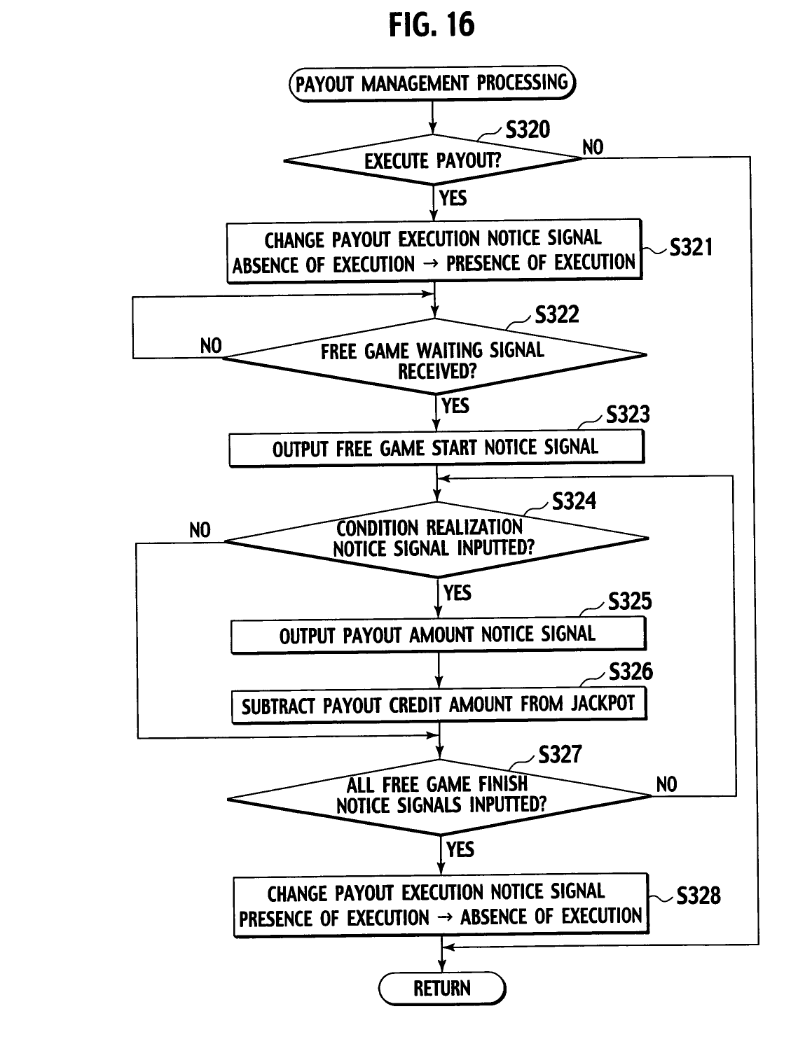

Also, at the payout management processing of the step S32, as shown in FIG. 16, the payout controller 3 judges whether the payout for each of the slot machines 10, 10A and 10B from the jackpot is to be executed or not (step S320). This judgment can be made by a lottery processing using random number table or the like, or by checking whether the credit amount accumulated in the jackpot has reached a certain value or not.

Then, in the case where it is not judged that the payout from the jackpot is to be executed (step S320 NO), the payout controller 3 terminates the payout management processing. Also, in the case where it is judged that the payout from the jackpot is to be executed (step S320 YES), the payout controller 3 changes the content of a payout execution notice signal to be outputted to each of the slot machines 10, 10A and 10B from the absence of the payout execution to the presence of the payout execution (step S321).

Next, at the step S322, the payout controller 3 waits for receiving the free game waiting signal from each of the slot machines 10, 10A and 10B. Then, when the free game waiting signals from all the slot machines 10, 10A and 10B are received (step S322 YES), the payout controller 3 outputs the free game start notice signal to each of the slot machines 10, 10A and 10B (step S323). Note that it is also possible to specify the predetermined game number or the predetermined point number of the slot games to be executed by each of the slot machines 10, 10A and 10B during the free game period, by this free game start notice signal.

Then, at the step S324, the payout controller 3 judges whether the condition realization notice signal from each of the slot machines 10, 10A and 10B is inputted or not (step S324). In the case where the condition realization notice signal is not inputted from any of the slot machines 10, 10A and 10B (step S324 NO), the processing proceeds to the step S327 to be described below.

Also, in the case where the condition realization notice signal is inputted from any of the slot machines 10, 10A and 10B (step S324 YES), the credit amount to be paid from the jackpot for the output source slot machine 10, 10A or 10B is determined and outputted to the output source slot machine 10, 10A or 10B as the payout amount notice signal (step S325). Here, the credit amount to be paid to the slot machines 10, 10A and 10b can be set such that it is made larger for one which inputted the condition realization notice signal earlier, or such that it is the same regardless of the order of inputting the condition realization notice signal. Also, the payout from the jackpot can be limited only to the output source slot machine 10, 10A or 10B of the condition realization notice signal that is inputted first, or the credit amount to be paid to those of the slot machines 10, 10A and 10B which are late in the order of inputting the condition realization notice signal can be set to “0”.

Next, at the step S326, the payout controller 3 subtracts the credit amount determined to be paid at the step S325 from the accumulated credit amount of the jackpot. Then, the payout controller 3 proceeds the processing to the step S327.

At the step S327, the payout controller 3 judges whether the free game finish notice signals are inputted from all the slot machines 10, 10A and 10B or not. In the case where the free game finish notice signals are not inputted from all the slot machines 10, 10A and 10B (step S327 NO), the payout controller 3 proceeds the processing to the step S324. In the case where the free game finish notice signals are inputted from all the slot machines 10, 10A and 10B (step S327 YES), the payout controller 3 changes the content of the payout execution notice signal to be outputted to each of the slot machines 10, 10A and 10B from the presence of the payout execution to the absence of the payout execution (step S328). Then, the payout controller 3 terminates the payout management processing.

In the slot machines 10, 10A and 10B of this embodiment in such configurations, as the content of the payout execution notice signal from the payout controller 3 is changed from the absence of the payout to the presence of the payout, the execution of the payout from the jackpot is notified from the payout controller 3. As a result, the free game consisting of the prescribed number of times of the slot games is executed at the slot machines 10, 10A and 10B by the operations of the players. Then, when the prescribed condition is realized during this free game period, the payout of credit from the jackpot managed by the payout controller 3 is executed at the slot machines 10, 10A and 10B.

Here, in the case where the slot game with the specific symbol as the scatter symbol is executed during the free game period at each of the slot machines 10, 10A and 10B, the prescribed condition is realized when the number of the slot games in which the scatter symbols in a number greater than or equal to the predetermined number are rearranged reaches the predetermined game number. Then, as the number of the specific symbols laid out on the circumferential face of each of the rotation reels 53a to 53e is different for each of the slot machines 10, 10A and 10B, the predetermined number is set higher for those of the slot machines 10, 10A and 10B for which the number of the laid out specific symbols is greater.

As a result, at the slot machine 10A for which the number of the specific symbols laid out on the circumferential face of each of the rotation reels 53a to 53e is the greatest and therefore their rearrangement probability is high, the prescribed condition will be realized by having the scatter symbols, that are rather easy to rearrange, rearranged in a large number in the slot games during the free game period. On the other hand, at the slot machine 10B for which the number of the specific symbols laid out on the circumferential face of each of the rotation reels 53a to 53e is the least and therefore their rearrangement probability is low, the prescribed condition will be realized by having the scatter symbols, that are rather hard to rearrange, rearranged even in a small number in the unit games during the free game period.

For this reason, the slot machine 10B for which the number of the specific symbols laid out on the circumferential face of each of the rotation reels 53a to 53e is less than the slot machine 10 and the rearrangement probability for the specific symbols is low will have a tendency of being capable of obtaining the payout from the jackpot for the free game by having the prescribed condition realized by the less number of rearranged scatter symbols than the slot machine 10A for which the number of the specific symbols laid out on the circumferential face of each of the rotation reels 53a to 53e is greater than the slot machine 10 and the rearrangement probability for the specific symbols is high, so that it has a higher gambling thrill.

Also, in the case where the slot game with the combination in which the specific symbol is rearranged in a region on the payline of the partitioned regions q11 to q53 as the winning combination is executed during the free game period at each of the slot machines 10, 10A and 10B, the prescribed condition is realized when a total of the points generated each time the winning combination using the specific symbol is realized on the payline reaches the predetermined point number. Then, as the number of the specific symbols laid out on the circumferential face of each of the rotation reels 53a to 53e is different for each of the slot machines 10, 10A and 10B, the points are set lower for those of the slot machines 10, 10A and 10B for which the number of the laid out specific symbols is greater.

As a result, at the slot machine 10A for which the number of the specific symbols laid out on the circumferential face of each of the rotation reels 53a to 53e is the greatest and therefore their probability for being rearrangement on the payline is high, the prescribed condition will be realized by having the winning combination using the specific symbol, that is rather easy to realize, realized on the payline in a large number of the slot games during the free game period, and accumulating the points in a lower value gradually until they reach the predetermined point number. On the other hand, at the slot machine 10B for which the number of the specific symbols laid out on the circumferential face of each of the rotation reels 53a to 53e is the least and therefore their probability for being rearrangement on the payline is low, the prescribed condition will be realized by having the winning combination using the specific symbol, that is rather hard to realize, realized on the payline even in a small number of the slot games during the free game period, and getting the points in a higher value sporadically until they reach the predetermined point number.

For this reason, the slot machine 10B for which the number of the specific symbols laid out on the circumferential face of each of the rotation reels 53a to 53e is less than the slot machine 10 and the probability for having the specific symbol rearranged on the payline is low will have a tendency of being capable of obtaining the payout for the free game by having the prescribed condition realized by the less number of times for realizing the winning combination using the specific symbol on the payline than the slot machine 10A for which the number of the specific symbols laid out on the circumferential face of each of the rotation reels 53a to 53e is greater than the slot machine 10 and the probability for having the specific symbol rearranged on the payline is high, so that it has a higher gambling thrill.

In this way, in either case of carrying out the slot game with the specific symbol as the scatter symbol or the slot game with the combination in which the specific symbol is rearranged on the payline as the winning combination during the free game period, the gambling thrill regarding the payout for the free game will be changed depending on a level of the rearrangement probability of the specific symbol. Then, this specific symbol is displayed on the foot display 34.

For this reason, it becomes possible for a player to recognize that the specific symbol of each of the slot machines 10, 10A and 10B that needs to be rearranged as the scatter symbol or the winning combination during the free game period in order to obtain the payout from the jackpot is respectively the symbol “character #1 (a face of a young male fighter)” (slot machine 10), the symbol “character #2 (a face of a young female fighter)” (slot machine 10A), and the symbol “character #3 (a face of a mature male fighter)” (slot machine 10B), which have mutually different rearrangement probabilities, before playing game, according to the symbol displayed on the foot display 34.

Consequently, according to the slot machines 10, 10A and 10B of this embodiment and their playing method, it becomes possible to realize the superior entertainment quality as the slot machines 10, 10A and 10B, by making a player to recognize that the gambling thrill regarding the payout from the jackpot is different at each of the slot machines 10, 10A and 10B, before playing the game, and enabling a player to play the game by selecting one of the slot machines 10, 10A and 10B having the gambling thrill that suits his own preference, from the slot machines 10, 10A and 10B which share the jackpot.

Also, in the slot machines 10, 10A and 10B of this embodiment, in the case where there is a need to rearrange the scatter symbols in a number greater than or equal to the predetermined number in the slot games in the predetermined game number during the free game period, the predetermined number is set higher for those of the slot machines 10, 10A and 10B for which the rearrangement probability of the specific symbol that is to become the scatter symbol is higher.

Similarly, in the slot machines 10, 10A and 10B of this embodiment, in the case where there is a need to make a total of the points generated when the winning combination using the specific symbol on the payline is realized to reach the predetermined point number in the slot games during the free game period, the points generated by the realization of the winning combination is set lower for those of the slot machines 10, 10A and 10B for which the rearrangement probability of the specific symbol is higher.

Consequently, even if the rearrangement probability for the specific symbol that needs to be rearranged during the free game period in order to obtain the payout from the jackpot is mutually different among the slot machines 10, 10A and 10B, the probability by which the payout from the jackpot can be obtained, as the number of the slot games in which the scatter symbols in a number greater than or equal to the predetermined number are rearranged reaches the predetermined game number, or as a total of the points generated when the winning combination using the specific symbol is realized on the payline reaches the predetermined point number, becomes the same among the slot machines 10, 10A and 10B.

For this reason, according to the slot machines 10, 10A and 10B of this embodiment and their playing method, the slot machines 10, 10A and 10B, for which the rearrangement probability for the specific symbol that needs to be rearranged during the free game period is mutually different, and hence the gambling thrill regarding the payout from the jackpot is mutually different, can be made to share the jackpot managed by the payout controller 3, at the equal payout probability.

Note that, in this embodiment, a configuration in which whether the prescribed condition for making the payout from the jackpot is realized or not is judged individually at each of the slot machines 10, 10A and 10B has been described. However, it is also possible to use a configuration in which whether the prescribed condition is realized or not is judged at the payout controller 3.

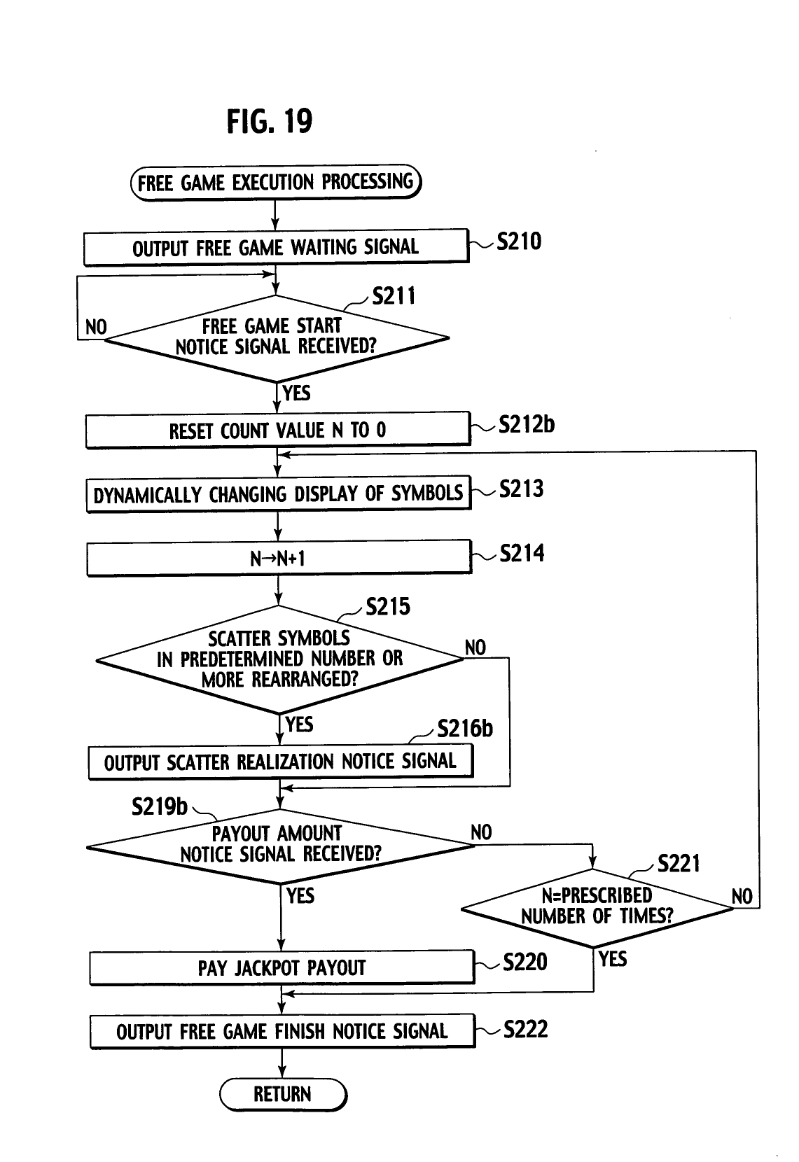

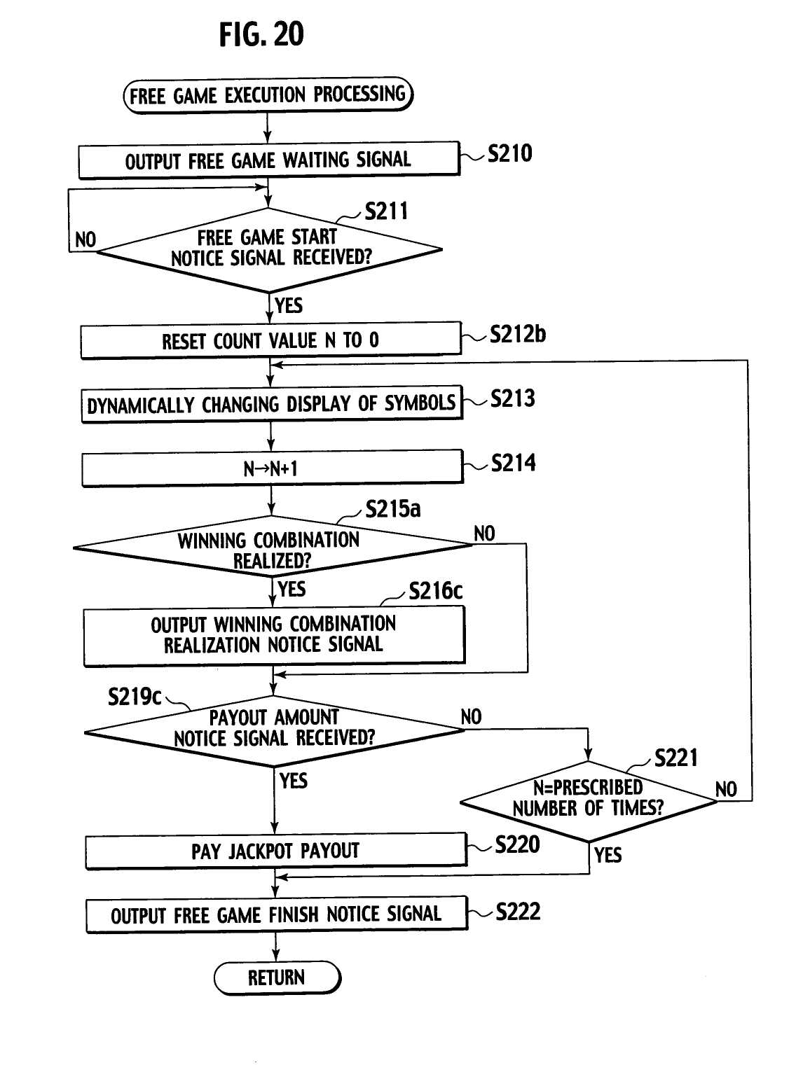

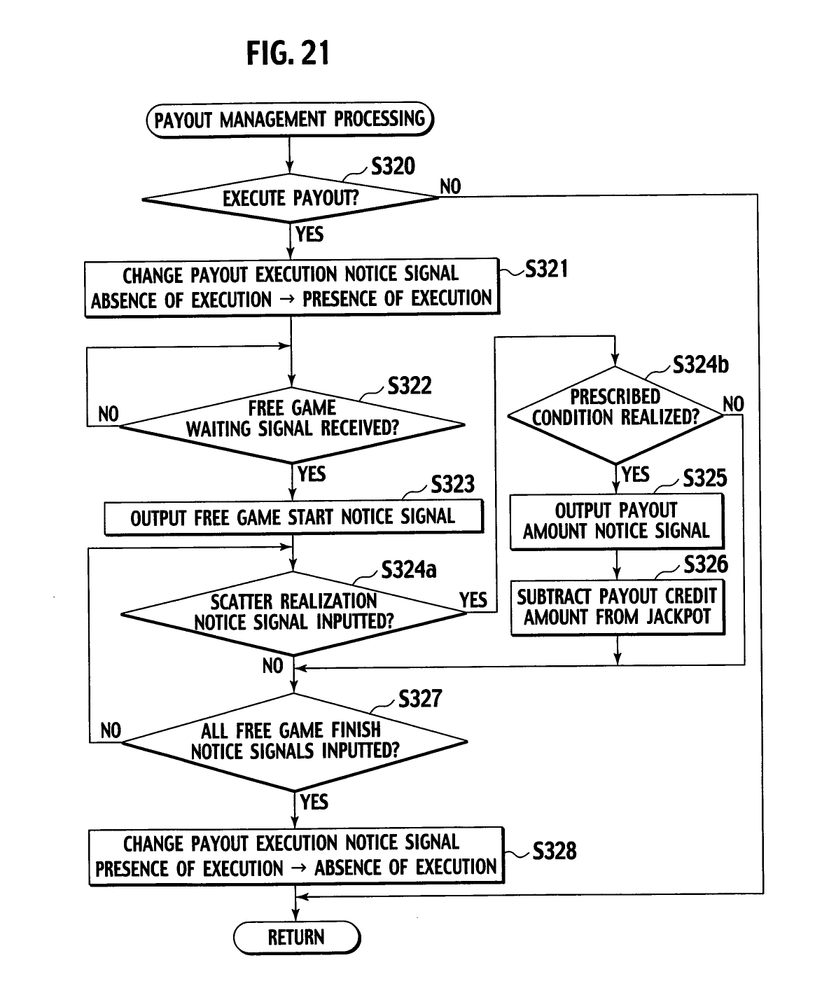

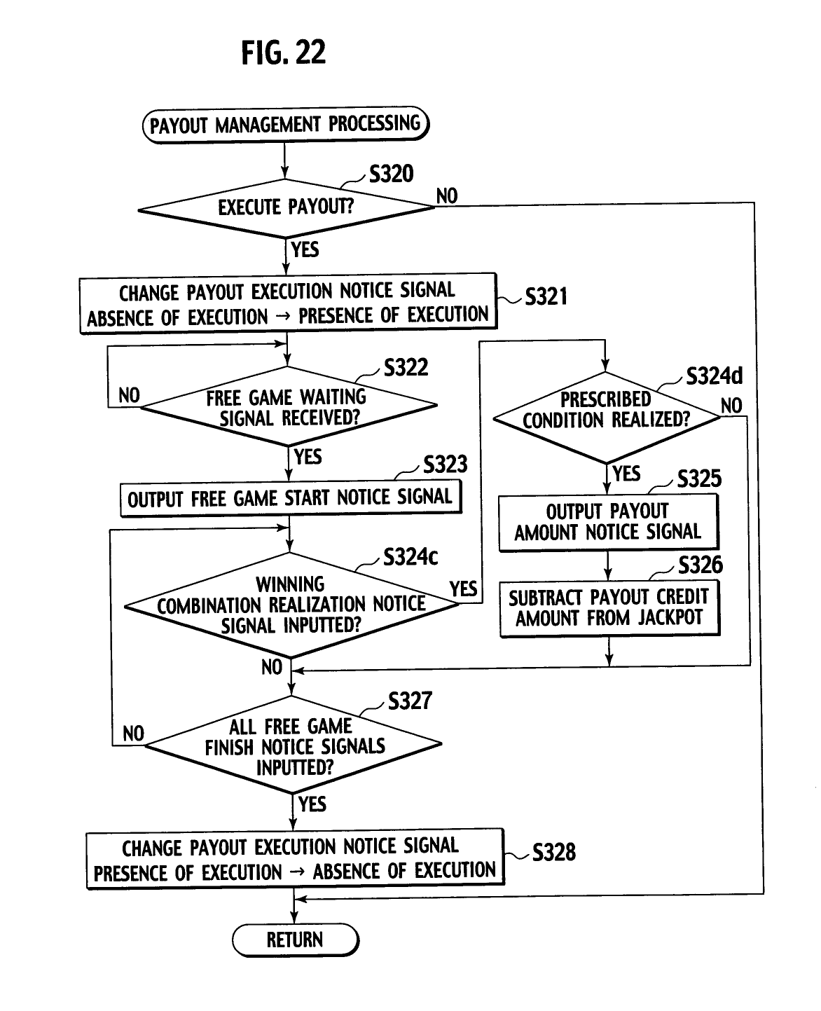

In the following, the slot machine according to the second embodiment in which whether the prescribed condition is realized or nor is judged at the payout controller 3 will be described with references to FIG. 19 to FIG. 22. FIG. 19 and FIG. 20 are flow charts showing the processing procedure of the slot machine according to the second embodiment of the present invention. FIG. 21 and FIG. 22 are flow charts showing the processing procedure of the payout controller of the slot machine system according to the second embodiment of the present invention.

In the slot machines 10, 10A and 10B according to the second embodiment of the present invention, the content of the free game execution processing to be carried out by the CPU 106 is partially different from the content of the free game execution processing in the first embodiment shown in FIG. 12 and FIG. 13. Also, in conjunction with this, in the slot machines 10, 10A and 10B according to the second embodiment of the present invention, the predetermined game number counter in the RAM 110 is omitted, and the management of the count n is not carried out.

For this reason, first, in each of the slot machines 10, 10A and 10B of the second embodiment, in the case of executing the slot game with the specific symbol as the scatter symbol for the prescribed number of times during the free game period, as shown in FIG. 19, the CPU 106 executes the processing of the step S210 to the step S215 of FIG. 12.

Here, however, at the step S212 of FIG. 12, the CPU 106 also carries out the resetting of the count value N of the free game counter provided in the RAM 110 to zero. The resetting of the count value n of the predetermined game number counter to zero is not carried out at the slot machines 10, 10A and 10B of the second embodiment. Consequently, as shown in FIG. 19, the CPU 106 of each of the slot machines 10, 10A and 10B of the second embodiment resets the count value N of the free game counter provided in the RAM 110 to zero at the step S212b, when the free game start notice signal from the payout controller 3 is received at the step S211 (step S211 YES).

Then, at the step S215, in the case where the scatter symbols (specific symbols) in a number greater than or equal to the predetermined number are rearranged in the partitioned regions q11 to q53 (step S215 YES), the CPU 106 outputs a scatter realization notice signal to the payout controller 3 (step S216b), and the processing proceeds to the step S219b to be described below. Also, in the case where the scatter symbols (specific symbols) in a number greater than or equal to the predetermined number are not rearranged in the partitioned regions q11 to q53 (step S215 NO), the processing proceeds to the step S219b.

At the step S219b, the CPU 106 judges whether the payout amount notice signal from the payout controller 3 is received or not. Then, in the case where the payout amount notice signal is received (step S219b YES), the CPU 106 pays the credit amount specified in the received payout amount notice signal as the payout from the jackpot (step S220). Note that there are cases where the credit amount specified in the payout amount notice signal is “0”. Then, the CPU 106 proceeds the processing to the step S222 to be described below.

On the other hand, in the case where the payout amount notice signal is not received at the step S219b (step S219b NO), at the step S221, the CPU 106 judges whether the count value N of the free game counter in the RAM 110 has reached the prescribed number of times (20 times in this embodiment), that is the number of the slot games to be executed during the free game period, or not.

In the case where the count value N of the free game counter has not reached the prescribed number of times (step S221 NO), the CPU 106 proceeds the processing to the step S213. In the case where the count value N has reached the prescribed number of times (step S221 YES), the CPU 106 proceeds the processing to the step S222.

At the step S222, the CPU 106 outputs a free game finish notice signal (step S222), and then terminates the free game execution processing.

Next, in each of the slot machines 10, 10A and 10B of the second embodiment, in the case of executing the slot game with the combination using the specific symbol as the winning combination for the prescribed number of times during the free game period, as shown in FIG. 20, the CPU 106 executes the processing of the step S210 to the step S215a of FIG. 13.

Here, however, at the step S212a of FIG. 13, the CPU 106 also carries out the resetting of the count value N of the free game counter provided in the RAM 110 to zero. The resetting of the count value m of the predetermined point number counter to zero is not carried out at the slot machines 10, 10A and 10B of the second embodiment. Consequently, as shown in FIG. 20, the CPU 106 of each of the slot machines 10, 10A and 10B of the second embodiment resets the count value N of the free game counter provided in the RAM 110 to zero at the step S212b, when the free game start notice signal from the payout controller 3 is received at the step S211 (step S211 YES).

Then, at the step S215a, in the case where the winning combination (the combination using the specific symbol) is realized on the payline (step S215a YES), the CPU 106 outputs a winning combination realization notice signal to the payout controller 3 (step S216c), and the processing proceeds to the step S219c to be described below. Also, in the case where the winning combination (the combination using the specific symbol) is not realized on the payline (step S215a NO), the processing proceeds to the step S219c.

At the step S219c, the CPU 106 judges whether the payout amount notice signal from the payout controller 3 is received or not. Then, in the case where the payout amount notice signal is received (step S219c YES), the CPU 106 pays the credit amount specified in the received payout amount notice signal as the payout from the jackpot (step S220). Note that there are cases where the credit amount specified in the payout amount notice signal is “0”. Then, the CPU 106 proceeds the processing to the step S222 to be described below.

On the other hand, in the case where the payout amount notice signal is not received at the step S219c (step S219c NO), at the step S221, the CPU 106 judges whether the count value N of the free game counter in the RAM 110 has reached the prescribed number of times (20 times in this embodiment), that is the number of the slot games to be executed during the free game period, or not.

In the case where the count value N of the free game counter has not reached the prescribed number of times (step S221 NO), the CPU 106 proceeds the processing to the step S213. In the case where the count value N has reached the prescribed number of times (step S221 YES), the CPU 106 proceeds the processing to the step S222.

At the step S222, the CPU 106 outputs a free game finish notice signal to the payout controller 3 (step S222), and then terminates the free game execution processing.

In addition, in the second embodiment, the content of the payout management processing to be carried out by the payout controller 3 at the step S32 of FIG. 14 is partially different from the content of the payout management processing in the first embodiment shown in FIG. 16.

Namely, first, in the second embodiment, in the case where each of the slot machines 10, 10A and 10B executes the slot game with the specific symbol as the scatter symbol for the prescribed number of times during the free game period, as shown in FIG. 21, the payout controller 3 executes the processing of the step S320 to the step S323 of FIG. 16.

Then, at the step S324a, the payout controller 3 judges whether the scatter realization notice signal from each of the slot machines 10, 10A and 10B is inputted or not. In the case where the scatter realization notice signal is not inputted from any of the slot machines 10, 10A and 10B (step S324a NO), the processing proceeds to the step S327 to be described below.

Also, in the case where the scatter realization notice signal is inputted from any of the slot machines 10, 10A and 10B (step S324a YES), whether the prescribed condition, which is a condition for executing the payment of credit as the payout for the free game at the slot machines 10, 10A and 10B, is realized or not is judged (step S324b). This judgment can be made by judging whether the number of the inputted scatter realization notice signals has reached the predetermined game number (“3” in this embodiment) or not. Also, whether the number of the inputted scatter realization notice signals has reached the predetermined game number or not may be judged separately for each of the slot machines 10, 10A and 10B that is the output source of the scatter realization notice signal, or may be judged by the total of the scatter realization notice signals inputted from each of the slot machines 10, 10A and 10B. Note that the predetermined game number can also be determined by the payout controller 3 every time it is determined to make the payout from the jackpot.

In the case where the prescribed condition is not realized (step S324b NO), the processing proceeds to the step S327. In the case where the prescribed condition is realized (step S324b YES), the payout controller 3 determines the credit amount to be paid from the jackpot for the slot machines 10, 10A and 10B and outputs it to the slot machines 10, 10A and 10B as the payout amount notice signal (step S325).

Here, in the case where whether the number of the inputted scatter realization notice signals has reached the predetermined game number or not is judged separately for each of the slot machines 10, 10A and 10B that is the output source of the scatter realization notice signal at the step S324a, the payout controller 3 will output the payout amount notice signal to each of the slot machines 10, 10A and 10B that is the output source. Also, in the case where whether the number of the inputted scatter realization notice signals has reached the predetermined game number or not is judged by the total of the scatter realization notice signals inputted from each of the slot machines 10, 10A and 10B at the step S324a, the payout controller 3 can output the payout amount notice signal to each of the slot machines 10, 10A and 10B. Else, it is also possible to output the payout amount notice signal only to one of the slot machines 10, 10A and 10B that is the output source of the latest scatter realization notice signal inputted at the step S324a.

Also, in the case where whether the number of the inputted scatter realization notice signals has reached the predetermined game number or not is judged separately for each of the slot machines 10, 10A and 10B that is the output source of the scatter realization notice signal at the step S324a, the credit amount to be paid to the slot machines 10, 10A and 10B can be set such that it is made larger for those of the slot machines 10, 10A and 10B for which the number of the inputted scatter realization notice signals has reached the predetermined game number earlier, or such that it is the same regardless of the order by which the number of the inputted scatter realization notice signals has reached the predetermined game number. Also, the payout from the jackpot can be limited only to one of the slot machines 10, 10A and 10B for which the number of the inputted scatter realization notice signals has reached the predetermined game number first, or the credit amount to be paid to those of the slot machines 10, 10A and 10B for which the order by which the number of the inputted scatter realization notice signals has reached the predetermined game number is late can be set to “0”.

Next, at the step S326, the payout controller 3 subtracts the credit amount determined to be paid at the step. S325 from the accumulated credit amount of the jackpot. Then, the payout controller 3 proceeds the processing to the step S327.

At the step S327, the payout controller 3 judges whether the free game finish notice signals are inputted from all the slot machines 10, 10A and 10B or not. In the case where the free game finish notice signals are not inputted from all the slot machines 10, 10A and 10B (step S327 NO), the payout controller 3 proceeds the processing to the step S324a. In the case where the free game finish notice signals are inputted from all the slot machines 10, 10A and 10B (step S327 YES), the payout controller 3 changes the content of the payout execution notice signal to be outputted to each of the slot machines 10, 10A and 10B from the presence of the payout execution to the absence of the payout execution (step S328). Then, the payout controller 3 terminates the payout management processing.

In contrast, in each of the slot machines 10, 10A and 10B of the second embodiment, in the case of executing the slot game with the combination using the specific symbol as the winning combination for the prescribed number of times during the free game period, as shown in FIG. 22, the payout controller 3 executes the processing of the step S320 to the step S323 of FIG. 16.

Then, at the step S324c, the payout controller 3 judges whether the winning combination realization notice signal from each of the slot machines 10, 10A and 10B is inputted or not. In the case where the winning combination realization notice signal is not inputted from any of the slot machines 10, 10A and 10B (step S324c NO), the processing proceeds to the step S327 to be described below.

Also, in the case where the winning combination realization notice signal is inputted from any of the slot machines 10, 10A and 10B (step S324c YES), whether the prescribed condition, which is a condition for executing the payment of credit as the payout for the free game at the slot machines 10, 10A and 10B, is realized or not is judged (step S324d). This judgment can be made by adding the prescribed points, that are determined in advance for the specific symbol (character #1 to character #3) of the slot machines 10, 10A and 10B that is the output source of the winning combination realization notice signal according to the respective rearrangement probability, to the total of the prescribed points accumulated so far, and judging whether the total of the prescribed points after the addition has reached the predetermined point number (“15” in this embodiment) or not. Also, whether the total of the prescribed points has reached the predetermined point number as a result of adding the prescribed points according to the inputted winning combination realization notice signal or not may be judged separately for each of the slot machines 10, 10A and 10B that is the output source of the winning combination realization notice signal, or may be judged by the total of all the prescribed points according to the winning combination realization notice signals inputted from each of the slot machines 10, 10A and 10B. Note that the predetermined point number can also be determined by the payout controller 3 every time it is determined to make the payout from the jackpot.

In the case where the prescribed condition is not realized (step S324d NO), the processing proceeds to the step S327. In the case where the prescribed condition is realized (step S324d YES), the payout controller 3 determines the credit amount to be paid from the jackpot for the slot machines 10, 10A and 10B and outputs it to the slot machines 10, 10A and 10B as the payout amount notice signal (step S325).

Here, in the case where whether the total of the prescribed points after the addition has reached the predetermined point number as a result of adding the prescribed points according to the inputted winning combination realization notice signal to the total of the prescribed points accumulated so far or not is judged separately for each of the slot machines 10, 10A and 10B that is the output source of the winning combination realization notice signal at the step S324c, the payout controller 3 will output the payout amount notice signal to each of the slot machines 10, 10A and 10B that is the output source. Also, in the case where whether the total of the prescribed points after the addition has reached the predetermined point number as a result of adding the prescribed points according to the inputted winning combination realization notice signal to the total of the prescribed points accumulated so far or not is judged by the total of all the prescribed points according to the winning combination realization notice signals inputted from each of the slot machines 10, 10A and 10B at the step S324c, the payout controller 3 can output the payout amount notice signal to each of the slot machines 10, 10A and 10B. Else, it is also possible to output the payout amount notice signal only to one of the slot machines 10, 10A and 10B that is the output source of the latest winning combination realization notice signal inputted at the step S324c.

Also, in the case where whether the total of the prescribed points according to the inputted winning combination realization notice signals has reached the predetermined point number or not is judged separately for each of the slot machines 10, 10A and 10B that is the output source of the winning combination realization notice signal at the step S324c, the credit amount to be paid to the slot machines 10, 10A and 10B can be set such that it is made larger for those of the slot machines 10, 10A and 10B for which the total of the prescribed points according to the inputted winning combination realization notice signals has reached the predetermined point number earlier, or such that it is the same regardless of the order by which the total of the prescribed points according to the inputted winning combination realization notice signals has reached the predetermined point number. Also, the payout from the jackpot can be limited only to one of the slot machines 10, 10A and 10B for which the total of the prescribed points according to the inputted winning combination realization notice signals has reached the predetermined point number first, or the credit amount to be paid to those of the slot machines 10, 10A and 10B for which the order by which the total of the prescribed points according to the inputted winning combination realization notice signals has reached the predetermined point number is late can be set to “0”.

Next, at the step S326, the payout controller 3 subtracts the credit amount determined to be paid at the step S325 from the accumulated credit amount of the jackpot. Then, the payout controller 3 proceeds the processing to the step S327.

At the step S327, the payout controller 3 judges whether the free game finish notice signals are inputted from all the slot machines 10, 10A and 10B or not. In the case where the free game finish notice signals are not inputted from all the slot machines 10, 10A and 10B (step S327 NO), the payout controller 3 proceeds the processing to the step S324c. In the case where the free game finish notice signals are inputted from all the slot machines 10, 10A and 10B (step S327 YES), the payout controller 3 changes the content of the payout execution notice signal to be outputted to each of the slot machines 10, 10A and 10B from the presence of the payout execution to the absence of the payout execution (step S328). Then, the payout controller 3 terminates the payout management processing.

Even by the slot machines 10, 10A and 10B of the modified example of the second embodiment in such configurations and their playing method, it is possible to obtain the same effects as the slot machines 10, 10A and 10B of the first embodiment and their playing method.

Moreover, in the first and second embodiments described above, the display 16 is formed by the transparent material, and the rearrangement of the symbols in the partitioned regions q11 to q53 are carried out by the rotation reel device arranged behind it.

However, it is also possible to use a configuration in which the rearrangement of the symbols in the partitioned regions q11 to q53 of the display 16 is carried out by the display of a liquid crystal panel provided in the display 16.

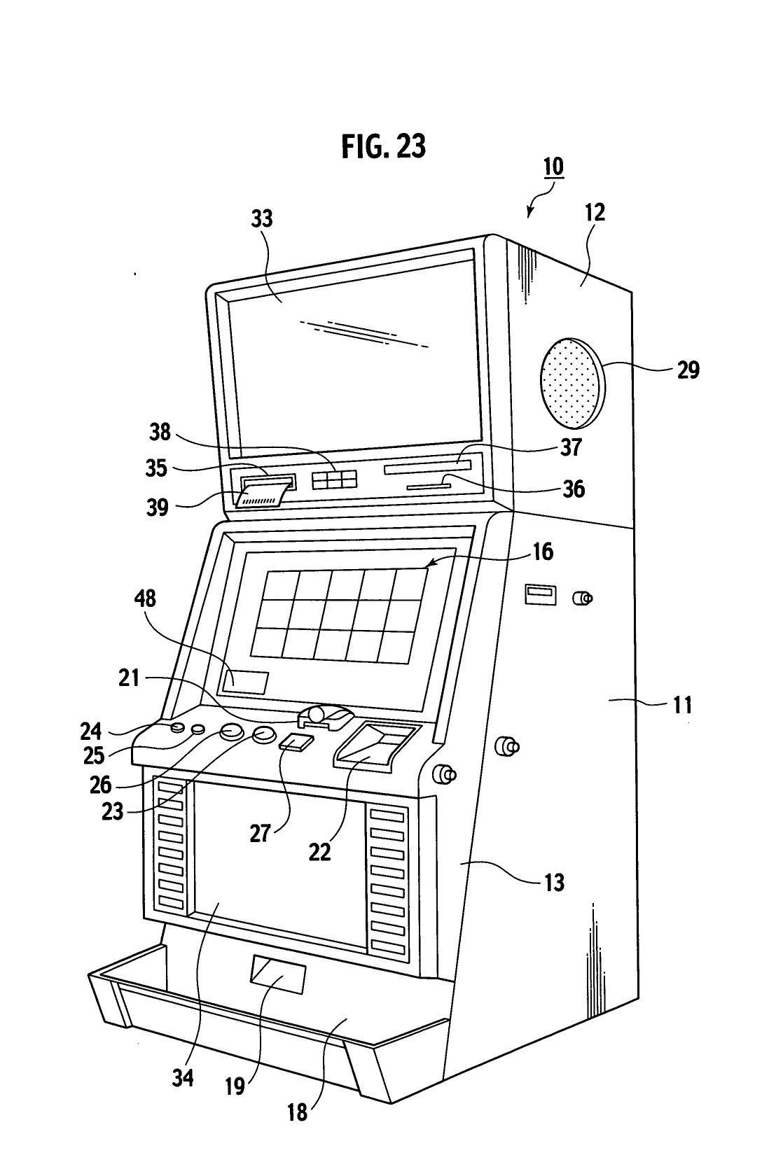

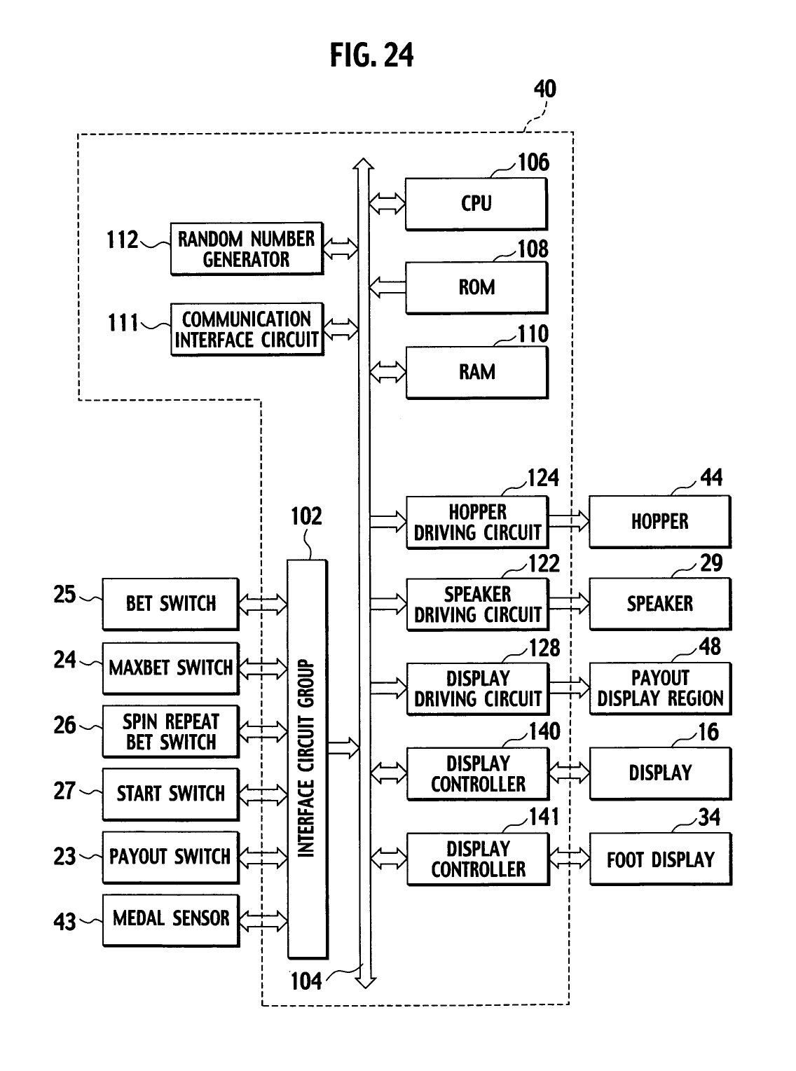

In the following, the slot machine according to the third embodiment of the present invention that carries out the rearrangement of the symbols by the display of the liquid crystal panel will be described. FIG. 23 is a perspective view of a slot machine according to the third embodiment of the present invention, and FIG. 24 is a block diagram showing a control circuit of a slot machine according to the third embodiment of the present invention.

As shown in FIG. 23, the slot machine 10 according to the third embodiment of the present invention omits the windows 16a to 16e on the display 16 and the rotation reel device 53 containing the rotation reels 53a to 53e that are arranged behind them (see FIG. 6A and FIG. 6B) of the slot machine 10 of the first and second embodiments.

Also, in the slot machine 10 of this embodiment, as shown in FIG. 24, the motor driving circuit 51 and the reel position detection circuit 52 of the machine controller 40 are omitted. Note that, in conjunction with the omission of the rotation reel device 53, the driving motors 56a to 56e of the rotation reel device 53 which are driven by the motor driving circuit 51 and the sensors 54a to 54e for detecting a rotation, a stopping and a stopping position of each of the rotation reels 53a to 53e of the rotation reel device 53 by the reel position detection circuit 52 are also omitted.

Note that, in the slot machine 10 of this embodiment, the display controller 140 carries out a display control for executing the effects according the slot game and the game outcome of the slot game. Namely, the CPU 106 generates an image display command signal according to a state of the slot game and an outcome of the slot game, and outputs this image display command signals to the display controller 140 through the input/output bus 104. When the image display command signal outputted from the CPU 106 is inputted, the display controller 140 generates a driving signal for driving the display 16 according to this image display command, and outputs this generated driving signal to the display 16. In this way, an effect screen according to the slot game and its outcome will be displayed on the display 16.

Consequently, the CPU 106 outputs the image display command for displaying an image of the slot game and an effect image according to its outcome on the display 16 to the display controller 140 at a timing according to a progress of the slot game. In this way, the effects according to the slot game and its game outcome will be made on the display 16.

Also, in the ROM 108, for each of the partitioned regions q11 to q53, a correspondence relationship between a code number indicating each symbol and one or a plurality of random numbers belonging to a prescribed numerical value range (0 to 255) is stored as a weight data. For example, for a certain symbol, when a plurality of random numbers corresponding to that symbol are set, a probability for that symbol to get selected becomes higher compared with a case of having one random number set.

In addition, in the stopped symbol determination processing of the step S15 of FIG. 11 to be carried out by the CPU 106 of the slot machine 10 of the first and second embodiments, the CPU 106 selects a random number from numerical values of “0 to 255” for each of the partitioned regions q11 to q53 by executing a random number generation program, and determines a stopped symbol for each of the partitioned regions q11 to q53 by referring to a correspondence between a random number and a symbol stored in the ROM 108.

Also, the CPU 106 carries out the processing for judging whether there is a win or not according to the symbols rearranged in the partitioned regions q11 to q53, at the step S17 in the slot game processing of FIG. 11, according to the content of the rearrangement of the symbols determined by the stopped symbol determination processing of the step S15.

Note that the slot machines 10A and 10B of the third embodiment which share the jackpot managed by the payout controller 3 with the slot machine 10 have configurations similar to the slot machine 10 of the third embodiment described above with references to FIG. 23 and FIG. 24.

Even by the slot machines 10, 10A and 10B of the modified example of the third embodiment in such configurations and their playing method, it is possible to obtain the same effects as the slot machines 10, 10A and 10B of the first and second embodiments and their playing method.

In the above, a slot machine and a playing method of a slot machine of the present invention have been described on bases of the embodiments shown in the figures, but the present invention is not limited to these, and a configuration of each unit can be replaced by an arbitrary configuration which has the similar functions.

For example, in the embodiments described above, the case where the partitioned regions of the display 16 have 15 partitioned regions q11 to q53 formed by five columns and three rows has been described, but a number of the partitioned regions arranged in a matrix shape that constitute the display is arbitrary in both the column direction and the row direction.

Also, the embodiments described above uses a configuration in which the credit as the payout for the free game (special game) is supplied from the jackpot in which a part of the credits bet in the slot games in a period other than the free game period is accumulated. However, the supply resources of the payout for the free game may not necessarily be one in which the payout amounts are progressively changed according to the credits bet in the slot games, as in the case of the jackpot.

Also, in the detailed description above, the characteristic portions are mainly described in order to make the present invention easily understandable. The present invention is not limited to the embodiments described in the detailed description above, and can be applied to the other embodiments, and its range of application is wide. Also, the terms and the terminology used in the present specification are used only for the purpose of explaining the present invention precisely, and not used for the purpose of limiting the interpretation of the present invention. Also, for those skilled in the art, it should be easy to contemplate other configurations, systems, methods, etc., that are contained in the concept of the present invention, from the content of the invention described in the present specification. Consequently, the description of the scope of claims should be construed as containing equivalent configurations within a range of not deviating from a range of the technical ideas of the present invention. Also, the purpose of the abstract is to make it possible for the patent office, the general public organizations, and technicians and the like who belong to the present technical field and who are not thoroughly familiar with patent and law terms or specialized terms, to quickly judge the technical content and its essence of the present application by a simple search. Consequently, the abstract is not intended to limit the scope of the invention which should be evaluated by the description of the scope of claims. Also, in order to sufficiently understand the purpose of the present invention and the effects specific to the present invention, they should preferably be interpreted by sufficiently referring to the documents and the like that are already disclosed in public.

In addition, the detailed description above contains the processing to be executed by a computer. The explanations and expressions in the above are described for the purpose of facilitating the most efficient understanding by those skilled in the art. In the present specification, each step used in deriving one result should be understood as a processing without a self-contradiction. Also, at each step, transmission and reception, recording, etc., of electric or magnetic signals will be carried out. In the processing at each step, such signals are expressed by bits, values, symbols, letters, terms, numbers, etc., but it should be noted that they are used simply because they are convenient for the purpose of explanation. Also, there are cases where the processing at each step is described by an expression common to the human behavior, but the processing described in the present specification is to be executed by various devices in principle. Also, the other configuration required in carrying out each step will be obvious from the above description.

What is claimed is:

1. A gaming machine comprising:
a first display configured to display a unit game in which a plurality of arranged symbols are rearranged;
a second display configured to display a character corresponding to a probability by which a specific symbol is rearranged in the unit game; and
a machine controller configured to
(a) execute a special game including the unit game for a prescribed number of times, according to a command from a payout controller, the gaming machine being connected to the payout controller along with other gaming machines, the gaming machine and each of the other gaming machines having different rearrangement probabilities for the specific symbol, and
(b) provide an award for the special game after a period of the special game, when a prescribed condition associated with a rearrangement of symbols including the specific symbol during the special game is fulfilled.

2. The gaming machine of claim 1, wherein the machine controller provides the award in an amount specified from the payout controller, when the prescribed condition associated with the rearrangement of symbols including the specific symbol at the gaming machine and a rearrangement of symbols including the specific symbol at the other gaming machines during the special game is fulfilled.

3. The gaming machine of claim 1, wherein the machine controller executes the special game according to the command notified from the payout controller when a progressive bonus accumulating some of an amount of bet placed for the unit game at each of the gaming machine and the other gaming machines reaches a certain amount.

4. A gaming machine comprising:
a first display configured to display a unit game in which a plurality of arranged symbols are rearranged;
a second display configured to display a character corresponding to a probability by which a specific symbol is rearranged in the unit game; and
a machine controller configured to
(a) execute a special game including the unit game for a prescribed number of times, according to a command from a payout controller, the gaming machine being connected to the payout controller along with other gaming machines, the gaming machine and each of the other gaming machines having different rearrangement probabilities for the specific symbol, and
(b) provide an award for the special game in an amount based on a game number of unit games in which a predetermined number of special symbols are rearranged during the special game, the predetermined number corresponding to the rearrangement probability for the special symbol.

5. The gaming machine of claim 4, wherein the machine controller provides the award in an amount notified from the payout controller based on the game number at the gaming machine during the special game, when a total of the game number at the gaming machine and the game numbers at the other gaming machines during the special game reaches a predetermined game number.

6. The gaming machine of claim 4, wherein the machine controller executes the special game according to the command notified from the payout controller when a progressive bonus accumulating some of an amount of bet placed for the unit game at each of the gaming machine and the other gaming machines reaches a certain amount.

7. A gaming machine comprising.
a first display configured to display a unit game in which a plurality of arranged symbols are rearranged;
a second display configured to display a character corresponding to a probability by which a specific symbol is rearranged in the unit game; and
a machine controller configured to
(a) execute a special game including the unit game for a prescribed number of times, according to a command from a payout controller, the gaming machine being connected to the payout controller along with other gaming machines, the gaming machine and each of the other gaming machines having different rearrangement probabilities for the specific symbol, and
(b) provide an award for the special game in an amount based on a total value of points during the special game, the points being given each time symbols are rearranged in a specific pattern with a level of difficulty of occurrence corresponding to a rearrangement probability of the specific symbol during the special game in an amount corresponding to the rearrangement probability of the specific symbol in the unit game.

8. The gaming machine of claim 7, wherein the machine controller provides the award in an amount notified from the payout controller based on the total value of the points given during the special game at the gaming machine, when a total of the total value of the points given during the special game at the gaming machine and the total value of the points given during the special game at the other gaming machines reaches a predetermined point number.

9. The gaming machine of claim 4, wherein the machine controller executes the special game according to the command notified from the payout controller when a progressive bonus accumulating some of an amount of bet placed for the unit game at each of the gaming machine and the other gaming machines reaches a certain amount.

10. A method of playing a gaming machine, comprising the steps of:
displaying a unit game in which a plurality of arranged symbols are rearranged, on a first display;
displaying a character corresponding to a probability by which a specific symbol is rearranged in the unit game, on a second display;
executing a special game including the unit game for a prescribed number of times, according to a command from a payout controller, the gaming machine being connected to the payout controller along with other gaming machines, the gaming machine and each of the other gaming machines having different rearrangement probabilities for the specific symbol, and
providing an award as a payout for the special game after a period of the special game, when a prescribed condition associated with a rearrangement of symbols including the specific symbol during the special game is fulfilled.

11. The method of claim 10, wherein the step of providing an award includes:
providing the award in an amount specified from the payout controller, when the prescribed condition associated with the rearrangement of symbols including the specific symbol at the gaming machine and a rearrangement of symbols including the specific symbol at the other gaming machines during the special game is fulfilled.

12. The method of claim 10, wherein the step of providing an award includes:
providing the award for the special game in an amount based on a game number of unit games in which a predetermined number of special symbols are rearranged during the special game, the predetermined number corresponding to the rearrangement probability for the special symbol.

13. The method of claim 12, wherein the step of providing an award includes:
providing the award in an amount notified from the payout controller based on the game number at the gaming machine during the special game, when a total of the game number at the gaming machine and the game numbers at the other gaming machines during the special game reaches a predetermined game number.

14. The method of claim 10, wherein the step of providing an award includes:
providing the award for the special game in an amount based on a total value of points during the special game, the points being given each time symbols are rearranged in a specific pattern with a level of difficulty of occurrence corresponding to a rearrangement probability of the specific symbol during the special game in an amount corresponding to the rearrangement probability of the specific symbol in the unit game.

15. The method of claim 14, wherein the step of providing an award for the special game in the amount based on the total value of points during the special game includes:
providing the award in an amount notified from the payout controller based on the total value of the points given during the special game at the gaming machine, when a total of the total value of the points given during the special game at the gaming machine and the total value of the points given during the special game at the other gaming machines reaches a predetermined point number.

16. The method of claim 10, wherein the step of providing an award includes:
executing the special game according to the command notified from the payout controller when a progressive bonus accumulating some of an amount of bet placed for the unit game at each of the gaming machine and the other gaming machines reaches a certain amount.
